(19) United States
(12) Patent Application Publication
(10) Pub. No.: US 2026/0127805 A1
(43) Pub. Date: May 7, 2026

(54) MULTIMODAL DIGITAL HUMAN INTERACTION SYSTEM

(71) Applicant: NVIDIA Corporation, Santa Clara, CA (US)

(72) Inventors: Guilhem Marie Andre Pierre Bau, La Mulatiere (FR); Tarun Jawahar Rathor, Pune (IN); Rohit Ramesh Vaswani, San Jose, CA (US); Severin Achill Klingler, Stettlen (CH); Pascal Joël Bérard, Zug (CH)

(21) Appl. No.: 19/381,603

(22) Filed: Nov. 6, 2025

Related U.S. Application Data
(60) Provisional application No. 63/717,883, filed on Nov. 7, 2024.

(51) Int. Cl. G06T 13/40; G06T 7/73

(52) U.S. Cl. CPC G06T 13/40; G06T 7/73

(57) ABSTRACT

Disclosed are apparatuses, systems, and techniques for a multimodal interaction system for digital humans with real-time engagement and pose analysis, which receive a video stream comprising a plurality of frames depicting at least a portion of a user, wherein the video stream is associated with an interaction of the user with an avatar; determine, for at least one frame of the plurality of frames, a pose orientation corresponding to at least one of one or more body landmarks of the user represented in the corresponding frame; determine, based on at least one of a series of pose orientations corresponding to the plurality of frames, an engagement metric of the user; and cause a representation of the avatar performing an action based on the engagement metric to be generated.

### RELATED APPLICATIONS

This application claims the benefit of U.S. Provisional Application No. 63/717,883, filed Nov. 7, 2024, the entire contents of which are incorporated herein by reference.

### TECHNICAL FIELD

At least one embodiment pertains to systems and techniques for implementing a multimodal interaction system for digital humans.

### BACKGROUND

Digital human and conversational AI systems have become increasingly prevalent in applications ranging from customer service and healthcare to entertainment and education. These systems typically rely on voice-based interactions where users speak to digital avatars or chatbots that process audio input through automatic speech recognition, and respond with synthesized speech or text. Current solutions focus primarily on understanding the semantic content of user utterances, and generating appropriate textual or vocal responses based on natural language processing algorithms.

### BRIEF DESCRIPTION OF DRAWINGS

Various embodiments in accordance with the present disclosure will be described with reference to the drawings, in which:

FIG. 1 is a block diagram of an example architecture of a computing system capable of performing real-time multimodal interaction system for digital humans, according to at least one embodiment;

FIG. 2 is a flow diagram of an example method determining an engagement metric of a user during an interaction with a digital human, according to at least one embodiment;

FIGS. 3A-B illustrate example video frames and graphs showing face angle measurements over time, according to at least one embodiment, according to at least one embodiment;

FIG. 4 illustrates a block diagram of an example multimodal interaction system architecture, according to least one embodiment;

FIG. 5A illustrates inference and/or training logic, according to at least one embodiment;

FIG. 5B illustrates inference and/or training logic, according to at least one embodiment;

FIG. 6 illustrates an example data center system, according to at least one embodiment;

FIG. 7 illustrates a computer system, according to at least one embodiment;

FIG. 8 illustrates a computer system, according to at least one embodiment;

FIG. 9 illustrates at least portions of a graphics processor, according to one or more embodiments;

FIG. 10 illustrates at least portions of a graphics processor, according to one or more embodiments;

FIG. 11 is an example data flow diagram for an advanced computing pipeline, in accordance with at least one embodiment;

FIG. 12 is a system diagram for an example system for training, adapting, instantiating and deploying machine learning models in an advanced computing pipeline, in accordance with at least one embodiment; and

FIGS. 13A and 13B illustrate a data flow diagram for a process to train a machine learning model, as well as client-server architecture to enhance annotation tools with pre-trained annotation models, in accordance with at least one embodiment.

### DETAILED DESCRIPTION

Modern voice and chatbot systems deployed as digital humans, interactive kiosks, or cloud-based agents lack a reliable mechanism to determine when an utterance captured from a shared acoustic environment is actually directed to the agent, or to another person or subject in the vicinity of the speaker. Current digital human interaction systems lack the ability to perceive and interpret visual cues from users, resulting in unnatural and ineffective conversations. In real-world settings, users routinely speak while glancing away, shift attention to bystanders mid-utterance, or carry on side conversations in proximity to a microphone. Existing digital avatars and chatbots cannot distinguish when users are actively engaged versus distracted, leading to inappropriate responses when users are looking away, talking to third parties, or otherwise not focused on the interaction.

Traditional systems often rely solely on audio input without understanding the user's visual context. When users engage in cross-talk or speak to someone else in a room, digital avatars cannot detect this and may inappropriately respond to conversations not directed at them. Similarly, when users become visually distracted or turn away during an interaction, the system traditionally continues to operate as if the user remains fully engaged, missing important contextual cues that would inform a more natural response.

The absence of real-time visual perception capabilities in digital human (also referred to as digital avatar) systems maintains a gap between human-to-human interactions, where visual engagement cues are naturally understood, and human-to-digital interactions, where such cues are ignored. This limitation reduces the effectiveness of digital humans in applications such as healthcare, customer service, and other scenarios where understanding user attention and engagement state may be important for providing appropriate responses.

Furthermore, existing computer vision solutions for human pose detection often perform poorly when users are partially occluded, not facing the camera directly, or operating under varying lighting conditions. These technical limitations prevent the development of attention detection systems that could enhance digital human interactions.

Aspects and embodiments of the present disclosure address these and other challenges of human-to-digital interactions by providing a multimodal interaction system for digital humans that enables real-time (or near real-time, e.g., without significant delay) engagement analysis and pose detection to facilitate natural human-to-digital interactions. A digital human can refer to a computer-generated avatar or virtual character that simulates human-like appearance and behavior for interactive communication purposes. While aspects of the present disclosure are described with respect to a digital human, the systems and method described herein are appliable to other types of computer-generated characters not limited to human-like avatars, such as anthropomorphic characters, virtual assistants, chatbots, animated creatures, robotic interfaces, cartoon characters, fantasy beings, and/or other interactive digital entities capable of conversational engagement. The system incorporates computer vision technology to track a user's body pose and head orientation, allowing a system controlling a digital avatar to determine whether a user is actively engaged or distracted during conversations.

The multimodal interaction system can include a real-time (or near real-time) perception pipeline that detects body landmarks. The system can track a user's attention, e.g., by detecting when the user turns their head or when their head is partially occluded, by employing pose estimation algorithms to derive 3D head orientations from 2D facial coordinates corresponding to a frame of a video. In some embodiments, a perception pipeline receives a video stream from a user device and runs an optimized body/face landmark detector to produce 2D key points. A downstream analytics pipeline estimates 3D head pose from the 2D key points, and can apply techniques (e.g., exponential weighted averaging) to stabilize jitter. Based on the estimated 3D head poses, the system can derive an engagement metric representing the level of attention of the user. The system can output the engagement metric as events according to configurable rules and thresholds.

In some embodiments, the architecture features multimodal sensor fusion that synchronizes visual perception data with audio processing data, accounting for different latency characteristics between vision and speech recognition pipelines. This temporal alignment allows the system to correlate what users say with their visual engagement state during the entire duration of their speech.

In some embodiments, the system can include customizable engagement rules with exponential smoothing to reduce false alerts. The system can adapt avatar conversation flow based on user engagement levels, e.g., by asking for clarification when users appear distracted or ignoring inputs when users are not engaged with the digital character.

In some embodiments, sensor-fusion and temporal alignment of vision-derived attention with audio-derived utterances can control turn-taking and avoid cross-talk. The system can correlate the time window spanning a user's utterance, offset by buffering and speech rate latencies, with the contemporaneous distribution of head pose derived attention states to enable a dialogue manager to gate, filter, ignore, and/or seek clarification on inputs determined not to be directed to the avatar. In some embodiments, the architecture can be implemented with a message bus linking a vision AI, vision analytics, audio analytics, and/or an avatar controller, and is designed to scale to multi-user scenarios via smart cropping and/or per-user attention tracking. Overall, the system provides a low-latency, real-time (or near real-time) mechanism to infer user engagement from vision, fuse it with audio, and/or use it to adapt digital human responses, improving interaction quality and reducing erroneous responses to off target speech.

The advantages of the disclosed embodiments include, but are not limited to, improvements over conventional digital human interaction systems through its multimodal sensor fusion architecture. By synchronization of visual perception data with audio processing while accounting for different latency characteristics between vision and speech recognition pipelines, the system provides temporal alignment that allows correlation of user speech with their visual engagement state throughout the duration of their utterances. This real-time (or near real-time) processing capability operates at high performance levels while maintaining low overall system latency. In some embodiments, the system described herein provides performance improvements over conventional solutions. For example, in embodiments the system described herein may operate at 1000 frames per second while maintaining low latency of approximate 32 milliseconds for visual processing. The technical improvement of the disclosed embodiments over conventional digital human interaction systems include, but are not limited to, enhanced processing efficiency, improved accuracy in user attention detection, and reduced false response rates. These advantages may be implemented through multimodal sensor fusion that correlates audio and visual data streams with different latency characteristics in embodiments. These technical improvements result in practical applications including more natural conversational AI systems that can distinguish between engaged users and cross-talk scenarios and reduced computational consumption by preventing inappropriate responses to off-target speech.

The systems and methods described herein may be used for a variety of purposes, by way of example and without limitation, these purposes may include systems or applications for machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray tracing, path tracing, etc.), collaborative content creation for 3D assets, digital twin systems, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine, unautomated vehicles that are manually operated), systems implemented using a robot, aerial systems, medical systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for generating or maintaining digital twin representations of physical objects, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the systems and methods described herein may be performed within a simulation environment (e.g., NVIDIA's DriveSIM) using simulated data (e.g., simulated sensor data of simulated sensors of a virtual or simulated machine). For example, simulated sensor data and/or map data may be used to identify regions of interest (e.g., parking spaces) and sub-regions of interest (e.g., sub-regions of a parking space that includes a curb, wheel stop, etc.) within the simulation environment, and may use this information to perform operations (e.g., parking) associated with the virtual machine within the environment. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. The synthetic training data (in addition to or alternatively from real-world data) may then be processed to determine geometry and/or other information related to regions of interest, such as parking spaces or pallet delivery locations within a warehouse, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

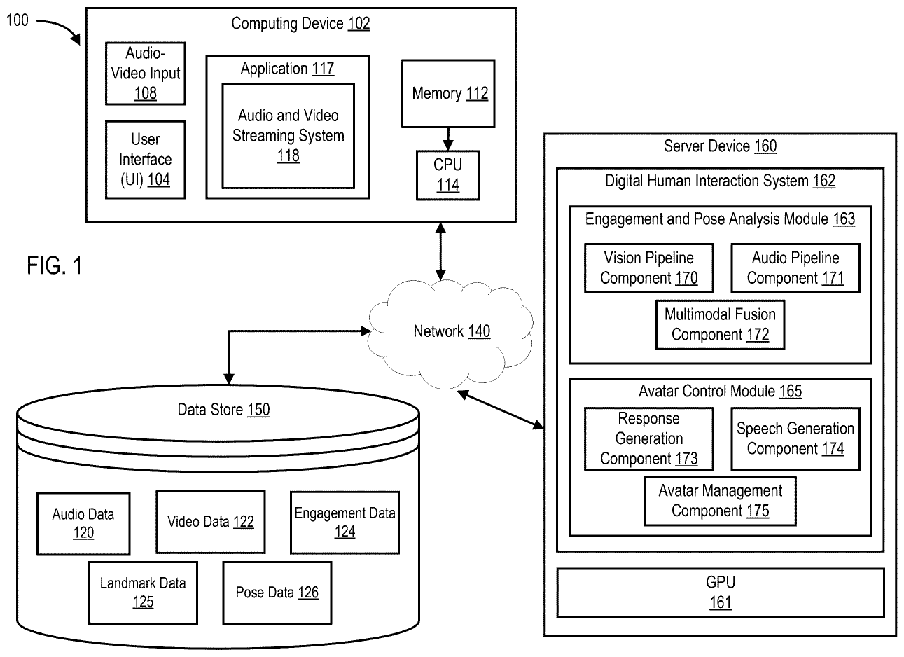

FIG. 1 is a block diagram of an example architecture of a computing system 100 capable of implementing multimodal digital human interactions through real-time (or near real-time, e.g., without significant delay) engagement and pose analysis, according to at least one embodiment. Real-time can include near real-time, meaning with negligible (e.g., milliseconds or microseconds) latency or delay. In some embodiments, real-time can refer to less than a threshold amount of delay. The system architecture 100 (also referred to as “system” herein) can include one or more computing device(s) 102, a server device 160, and/or a data store 150, where any, some, or all of which may be connected via a network 140. It should be noted that system 100 can additionally or alternatively include other components (e.g., one or more server machines, data store(s), etc.) connected to computing device 102, etc., via network 140. In implementations, network 140 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, data store 150 is a persistent storage that is capable of storing data as well as data structures to tag, organize, and/or index the data. Data store 150 can be hosted by one or more storage devices, such as main memory, magnetic or optical storage based disks, tapes or hard drives, NAS, SAN, and so forth. In some implementations, data store 150 can be a network-attached file server, while in other embodiments data store 150 can be some other type of persistent storage such as an object-oriented database, a relational database, and so forth, that may be hosted by computing device 102 or one or more different machines coupled to computing device 102 via network 140. In some embodiments, data store 150 can include audio data 120, video data 122, engagement data 124, landmark data 125, and/or pose data 126. In some embodiments, the data store 150 can include a cloud-based storage system, a distributed database, and/or a message broke architecture that provide high-speech access to the data for real-time (or near real-time) processing. The storage system of data store 150 can be configured to handle streaming audio and/or video data with low latency access patterns.

In some embodiments, audio data 120 can include digital audio streams captured from a user device (e.g., computing device 102), e.g., during an interaction between a user of the user device and a digital human (e.g., an avatar). The audio data can be stored, transmitted, or processed in a variety of formats. The audio data 120 can include voice utterances, speech patterns, and/or ambient audio information, in embodiments. In some embodiments, the audio data 120 can be encoded in real-time streaming formats compatible with real-time streaming protocols (RTSP). The audio data 120 can include raw audio samples and/or processed audio segments that have undergone voice activity detection (VAD) to identify when a user is speaking versus silent periods (e.g., to identify when a user has stopped speaking). In some embodiments, the audio data 120 can include temporal markers and/or synchronization information that correlate with corresponding video frames (e.g., stored as video data 122). In some embodiments, the audio data 120 can include metadata, such as speech timing information, utterance duration, word count estimations, and/or processing latency measurements, that can be used to calculate audio pipeline delays for sensor fusion.

In some embodiments, video data 122 can include digital video stream captured from a user device (e.g., computing device 102), e.g., during an interaction between a user of the user device and a digital human (e.g., an avatar). The video data 122 can include multiple image frames. In some embodiments, the frames of video data 122 can be transmitted via RTSP streaming protocols. In some embodiments, the video data 122 can include sequential image frames that capture user body positioning, facial expressions, and/or head orientation information. In some embodiments, video data 122 can include processed frame data that has undergone computer vision analysis, containing extracted body landmark coordinates for a number of anatomical points. The anatomical points can include, for example, facial features (e.g., nose, eyes, ears, and so on), upper body joints (e.g., shoulders, elbows, wrists, and so on), and/or lower body joints (e.g., hips, knees, ankles, and so on). In some embodiments, each landmark can have an associated two-dimensional coordinate position, and optionally a confidence score (e.g., ranging from 0.0 to 1.0) that indicates the reliability of the landmark detection. In some embodiments, the video data 122 can include derived analytical data such as 3D pose estimations. In embodiments, 3D pose estimations may include yaw, pitch, and roll angles computed from facial landmark coordinates (e.g., by the digital human interaction system 162). In some embodiments, the analytical data can include smoothed angle measurements. The smoothed angle measurements may be angle measurements that have been processed through exponential weighted averaging to reduce jitter. In embodiments, the video data 122 can include analytical data such as temporal synchronization markers that correlate video frame(s) with corresponding audio segments.

In some embodiments, landmark data 125 can include data representing anatomical reference points detected from an image (e.g., a video frame of video data 122) of a user during an interaction with a digital human. In some embodiments, landmark data 125 can include two-dimensional coordinate positions (x, y coordinates) for any number of identified body landmarks. The landmarks can include, for example, facial features such as nose, eyes, and/or ears, upper body joints such as shoulders, elbows, and/or wrists, and/or lower body joints such as hips, knees, and/or ankles. In some embodiments, the landmark data 125 can include a confidence score for each 2D coordinate. The confidence score can range for 0.0 to 1.0, and can indicate the reliability and/or certainty of the landmark prediction (e.g., as provided by an artificial intelligence model). In some embodiments, the landmark data 125 can include temporal information linking the landmark coordinate(s) to a specific video frame and/or timestamps. The temporal information can enable the digital human interaction system 162 to track body pose changes over time during a user's interaction with a digital human. In some embodiments, the landmark data 125 can include filtered and/or validated landmark information, where landmark data with confidence scores above a predetermined and/or configurable threshold is retained for further processing. In some embodiments, the landmark data 125 can include processed facial landmark subsets extracted for head pose estimation calculations, containing coordinate data for facial reference points used to derive three-dimensional head orientation coordinates.

In some embodiments, pose data 126 can include three-dimensional head orientation data, which may be derived from the 2D facial landmark coordinates (e.g., of landmark data 125). In some embodiments, pose data 126 can include yaw, pitch, and roll angles measured in degrees that quantify the rotational orientation of a user's head relative to the camera or digital human interface. Such pose data 126 enables determination of a user's attention direction and/or engagement levels in embodiments. In some embodiments, pose data 126 can include raw angle measurements and/or smoothed angle values (e.g., processed through exponential weighted averaging techniques) to reduce jitter and noise in real-time (or near real-time) pose tracking. For example, the smoothing algorithm can apply configurable alpha parameters where

$$smooth\_angle ( t ) = alpha * angle ( t ) + ( 1 - alpha ) * smooth\_angle ( t - 1 ) ,$$

with higher alpha values providing more responsive angle tracking. In some embodiments, the pose data 126 can include intermediate processing results, such as rotation matrices, translation vectors, and/or reference 3D facial model parameters used to extrapolate 2D facial coordinates to fit standard facial dimensions. In some embodiments, pose data 126 can include temporal synchronization markers correlating head pose measurements with specific video frame timestamps and/or corresponding audio segments for multimodal sensor fusion. In some embodiments, pose data 126 can include statistical distributions of head pose orientation over time periods corresponding to user speech utterances.

In some embodiments, engagement data 124 can include data representing a user engagement metric that represents the user's attention level and/or engagement state derived from real-time (or near real-time) analysis of user pose and/or head orientation (e.g., stored as pose data 126) during an interaction with a digital human. In some embodiments, the engagement data 124 can include statistical distributions of user attention metrics (e.g., pose data 126) calculated over specific time periods, such as the percentage of time during an audio utterance that a user maintained engagement above a predetermined threshold. In some embodiments, engagement data 124 can contain engagement classification results indicating whether a user is in an attentive, a distracted, and/or a disengaged state. In embodiments, engagement classification results may be based on head pose angle measurement(s) and customizable alert rules. In some embodiments, the classification data can include temporal data that correlates user attention states with corresponding speech timing information. In some embodiments, engagement data 124 can include processed engagement events and/or alerts. Such events and/or alerts may be generated when a user's attention level transitions between different states, such as when a user shifts from engaged to distracted. The event data can contain timestamps, engagement duration metrics, and/or confidence scores associated with attention state determinations. In some embodiment, the attention state determinations may be derived from exponential smoothing algorithms applied to raw pose estimation data.

Computing device 102 may include a computing device, a desktop computer, a laptop computer, a smartphone, a tablet computer, a server, a wearable device, a virtual/augmented/mixed reality headset or head-up display, a digital avatar or chatbot kiosk, and/or any other suitable computing device capable of performing the techniques described herein. Computing device 102 may be configured to communicate with user via user interface (UI) 104. The user may be an individual user (e.g., an owner or user of a computer, vehicle, machine, entertainment equipment), a collective user (e.g., a business organization, an institution, a government agency, and/or the like), an agent of a repair facility, and/or the like.

UI 104 may include one or more devices of various modalities, such as a keyboard, a touchscreen, a touchpad, a writing pad, a graphical interface, a mouse, a stylus, and/or any other device capable of receiving user interactions with a user interface displayed on a screen, and/or some other suitable device. In some embodiments, UI 104 may include an audio device. The audio device may include a microphone, a speaker, or a combination thereof, a video device, such as a digital camera to capture an image or a sequence of two or more images (e.g., frames), a display device (e.g., a display for an infotainment system in a machine (such as a vehicle), a dashboard display in a machine, etc.), or a combination thereof. In some embodiments, text, speech, and/or video input devices may be integrated together (e.g., into a smartphone, tablet computer, desktop computer, automobile infotainment system, and/or the like).

In some embodiments, computing device 102 can include an audio-video input 108 that can receive audio and/or video data from sensors. For example, audio-video input 108 can receive audio data from one or more audio sensors that can capture audio. An audio sensor(s) can be, for example, a microphone, such as dynamic microphone, a condenser microphone, a ribbon microphone, a unidirectional microphone, an omnidirectional microphone, and/or any other type of microphone. In some embodiments, a microphone can be combined with other devices, such as computers, phones, speakers, TV screens, and/or the like. The audio data collected by the audio sensors may be generated (e.g., spoken) by any number of speakers and may include a single speech episode or multiple speech episodes. In some embodiments, a speech episode can refer to a segment of an interaction session that can include a single utterance or multiple sequential utterances from a user. In some embodiments, a speech episode can be characterized by start and stop points determined through voice activity detection that can distinguish between period of active speech and silence. In some embodiments, a speech episode can correspond to a complete conversational turn, a response to a question, or any bounded sequence of communication. In some embodiments, multiple speech episodes can occur within a single interaction. In some embodiments, the audio-video input 108 can store collected audio data in memory 112, and/or in audio data 120 of data store 150. Thus, audio-video input 108 can receive audio of a user of computing device 102 speaking into a microphone, for example. As an illustrative example, the user can provide speech as part of an interaction with a digital human. Audio data 120 can represent any audio sounds, such as spoken word, music, ambient sounds, sound effects, animal sounds, machine or mechanical sounds, and so on. In some embodiments, audio data 120 of data store 150 can include audio data that was previously generated and/or received. For example, audio data 120 of data store 150 can store data received from server device 160.

Audio-video input 108 can receive video data from one or more sensors that can capture video. In some embodiments, the sensor(s) can capture both audio and video data. A video sensor can be, for example, a camera (e.g., such as a webcam, a digital camera, an infrared camera, and/or other optical imaging device capable of capturing real-time video streams). In some embodiments, a camera can be combined with other devices, such as computers, phones, speakers, TV screens, and/or the like. The video data collected by the video sensors may be generated by any number of users of the device 102. In some embodiments, the audio-video input 108 can store collected video data in memory 112, and/or in video data 122 of data store 150. Thus, audio-video input 108 can receive video of a user of computing device 102 while the user interacts with a digital human, for example. Video data 120 can represent any visual elements, such as the user's body position, head movements, facial features, background scenes, and so on. In some embodiments, video data 122 of data store 150 can include video data that was previously generated and/or received. For example, video data 122 of data store 150 can store data received from server device 160.

In some embodiments, audio-video input 108 can receive audio and/or video data continuously during an active user session with a digital human, capturing real-time (or near real-time) audio and/or video streams when the user is engaged in conversation or interaction with the digital human. In some embodiments, the audio-video input 108 can be triggered to begin data capture when a user initiates a session, e.g., through a web browser interface, and/or when field-of-view entry conditions are detected. In some embodiments, once triggered, the audio-video input 108 can continue to capture audio and/or video throughout the duration of the interaction sessions, and/or until a predetermined condition has been met.

In some embodiments, the received audio and/or video data can be temporarily buffered in memory 112 of computing device 102. Such buffering may be performed before being transmitted via the audio and video streaming system 118 to the digital human interaction system 162. In some embodiments, the audio-video input 108 can utilize network 140 to stream the captured data in real-time (or near real-time) to the digital human interaction system 162. Such streaming may be performed, for example, using protocols such as web real-time communication (webRTC) protocol or RTSP. The digital human interaction system 162 can store the streamed audio and/or video data as audio data 120 and video data 122, respectively.

In some embodiments, computing device 102 can include or implement an application 117. Application 117 can be or include a software application, such as a web browser, a desktop application, a mobile application (e.g., a smartphone or tablet application), etc. Application 117 can facilitate a user interaction with a digital human system through multimodal interfaces. Application 117 can include or implement an audio and video streaming system 118. In some embodiments, audio and video streaming system 118 can include software, hardware, and/or firmware configured to perform one or more operations with respect to providing bidirectional streaming capabilities for capturing and receiving audio and/or video data. The bidirectional streaming capabilities can enable real-time (or near real-time) communication between the computing device 102 and the server device 160, in particular the digital human interaction system 162. In some embodiments, the audio and video streaming system 118 can implement streaming functionality that captures audio and/or video data. In some embodiments, the audio and video streaming system 118 can capture audio and/or video data from audio-video input 108. In some embodiments, the audio and video streaming system 118 can implement streaming functionality that transmits the audio and/or video data to server device 160 via network 140. For example, the audio and video streaming system 118 can capture and/or transmit audio and/or video data using webRTC protocol or similar streaming protocols. In some embodiments, the audio and video streaming system 118 can include a media encoding module that can compress audio and/or video streams for efficient transmission over network 140. In some embodiments, the audio and video streaming system 118 can implement a buffer mechanism to temporarily store streaming data in memory 112 before transmission. In some embodiments, the audio and video streaming system 118 can include a synchronization component that maintains temporal alignment between audio and video streams during capture and/or transmission.

In some embodiments, the audio and video streaming system 118 can include media decoding capabilities to process incoming audio and/or video streams from the digital human interaction system 162. The incoming audio and/or video streams can include synthesized speech from a text-to-speech engine and/or rendered video of a digital human. The audio and video streaming system 118 can implement playback buffer management to provide smooth audio and video presentation through the UI 104, while coordinating with the CPU 114 during real-time (or near real-time) streaming operations. In some embodiments, the audio and video streaming system 118 can handle protocol negotiation and/or error recovery mechanisms to maintain connection stability during extended interaction sessions.

Server device 160 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components.

In some embodiments, server device 160 can include or implement a digital human interaction system 162. In some embodiments, the digital human interaction system 162 can include software, hardware, and/or firmware configured to perform one or more operations with respect to performing real-time (or near real-time) engagement analysis and pose detection for human-to-digital interactions. The digital human interaction system 162 can be (or include) a cloud-based multimodal processing architecture that enables real-time (or near real-time) engagement analysis and pose detection for human-to-digital interactions. In some embodiments, the digital human interaction system 162 can include an engagement and pose analysis module 163 and/or an avatar control module 165.

In some embodiments, the engagement and pose analysis module 163 can perform real-time (or near real-time) analysis of a user's visual behavior and attention states during an interaction with a digital human. In some embodiments, the engagement and pose analysis module 163 can process incoming video streams to extract body pose information and determine engagement metrics that quantify user attention levels and interaction quality. In some embodiments, the engagement and pose analysis module 163 can coordinate the processing of visual perception data through pipeline components that handle different aspects of the analysis workflow. For example, the workflow can include pose detection and user engagement classification to determine a user's engagement metric(s). In some embodiments, the engagement and pose analysis module 163 can provide the avatar control module 165 with the contextual awareness to adapt conversation flow based on a user's engagement metric(s). In some embodiments, the engagement and pose analysis module 163 can include a vision pipeline component 170, an audio pipeline component 171, and/or a multimodal fusion component 173.

In some embodiments, the vision processing pipeline 170 can implement perception using vision AI, and can perform vision analytics. In some embodiments, the vision processing pipeline 170 can receive video and/or audio streams (e.g., can receive an RTSP stream) from a computing device 102. The vision processing pipeline 170 can perform real-time (or near real-time) body pose detection. In embodiments, one or more trained artificial intelligence (AI) models such as machine learning (ML) models capable of identifying numerous anatomical landmarks may be used. The anatomical landmarks can include, for example, facial features, upper body joints, and/or lower body joints. In at least one implementation, the AI model(s) can detect multiple (e.g., up to 17 or more) different anatomical landmarks, including facial reference points (nose, left eye, right eye, left ear, right ear), upper body joints (left shoulder, right shoulder, left elbow, right elbow, left wrist, right wrist), and/or lower body joints (left hip, right hip, left knee, right knee, left ankle, right ankle). The landmarks can be represented by 2D coordinates (e.g., x, y coordinates) corresponding to a frame of a video stream, and can be stored as landmark data 125. In some embodiments, the video data is 3D data, and the vision pipeline component 170 processes the 3D data to determine landmarks represented by 3D coordinates (e.g., x, y, z coordinates). The machine learning model can provide, for each identified landmark, a confidence score that represents the reliability or certainty of the model's landmark prediction. For example, the confidence score can be a value between 0 and 1, where the lower the confidence score, the higher the probability that the detection is unreliable.

In some embodiments, the ML model can process pixel data representing an image or video frame and outputs two-dimensional or three-dimensional coordinates for each detected landmark. In some embodiments, the ML model can employ a convolutional neural network (CNN) or a hybrid architecture incorporating depthwise separable convolutions and attention-based layers to efficiently extract spatial and contextual features from the input image. The extracted feature maps are processed through successive encoder and decoder stages that predict heatmaps and offset vectors indicating the likelihood and precise location of each landmark. The model may operate in either a single-person detection mode or a multi-person detection mode, where multiple sets of landmarks are identified and associated with distinct individuals in the frame. The ML model may be trained using large-scale human pose datasets comprising labeled landmarks for diverse postures, body shapes, and environmental conditions, enabling generalization across varied lighting, backgrounds, and camera perspectives.

In some embodiments, the vision processing pipeline 170 can determine a facial area of the user based on the 2D or 3D body pose landmarks. In some embodiments, the vision processing pipeline 170 can determine a facial bounding box from detected landmarks. The vision processing pipeline 170 can identify the multiple landmark 2D or 3D coordinates (in a video frame. The vision processing pipeline 170 can filter the facial landmarks, disregarding the landmark(s) not associated with the face of the user. The vision processing pipeline 170 can determine whether the number of facial landmarks that have a corresponding confidence score satisfies a criterion. For example, the vision processing pipeline 170 can determine, for each facial landmark, whether the corresponding confidence score exceeds a confidence threshold. If the number of facial landmarks whose confidence scores exceed a minimum value (e.g., is greater than three), the vision processing pipeline 170 can determine that criterion has been satisfied. If the criterion has not been satisfied, the vision processing pipeline 170 can stop analysis on that video frame and proceed with processing the next frame in the series of frames of the video stream. If the criterion has been satisfied, the vision processing pipeline 170 can compute a bounding box (e.g., a rectangle, or other appropriate shape such as a circle) that covers the facial landmarks. In some embodiments, the bounding box can include some padding (e.g., can be slightly bigger than the area covering the facial features). In some embodiments, the bounding box can cover all detected facial features, or can cover the facial features whose confidence scores exceeds a threshold value (e.g., the threshold value can the same confidence threshold above, or can be a different (e.g., lower) threshold value). In some embodiments, the identified facial landmarks and/or the bounding box coordinates can be stored as landmark data 125 of data store 150.

In some embodiments, the vision processing pipeline 170 can implement a perception analytics pipeline that can determine three-dimensional head pose orientation from two-dimensional facial landmark coordinates. In some embodiments, the 3D head pose orientation can be determined using a perspective-n-point pose estimation algorithm. The perception analytics pipeline can determine yaw, pitch, and roll angles to quantify user engagement in embodiments. User engagement can refer to the level of user attention and focus directed toward the digital human interface, as determined by an analysis of head pose orientation. This information may be used to assess whether a user is actively engaged in the interaction or distracted by other activities or conversations. In some embodiments, the perception analytics pipeline can smooth the yaw, pitch, and roll/or angle measurements and reduce jitter in real-time pose tracking, for example by applying exponential weighted averaging techniques. The perception analytics pipeline can generate an engagement metric that classifies whether a user is in an attentive state, a distracted state, or a disengaged state. The engagement metric can be based on customizable alert rules and/or confidence thresholds.

In some embodiments, the engagement and pose analysis module 163 can implement an audio pipeline component 171. In some embodiments, the audio pipeline component 171 can include a digital signal processing system configured to receive and analyze audio streams from user devices (e.g., from computing device 102) to enable speech recognition and/or synthesis capabilities for digital human interactions. In some embodiments, the audio pipeline component 171 can include voice activity detection (VAD) algorithms to identify when a user is speaking versus silent to determine when a user's utterance is complete. The audio pipeline component 171 can store, as part of audio data 120, temporal information (e.g., timestamps) to indicate when a user is speaking versus silent. The temporal information can also indicate the particular utterance or speech session.

Audio pipeline component 171 may include one or more trained AI models that have been trained to process audio data and output speech recognition results, voice activity detection events, and/or synthesized speech responses for a digital human interaction. In some embodiments, the audio pipeline component 171 can incorporate one or more automatic speech recognition (ASR) models to convert user audio utterances into text. In some embodiments, the audio pipeline component 171 can incorporate one or more text-to-speech (TTS) synthesis models to generate synthesized speech responses from the digital human system (e.g., from the avatar control module 165). In some embodiments, the audio pipeline component 171 can include buffering mechanisms that manage temporal alignment between audio processing latencies and visual perception data (e.g., as described with respect to the multimodal fusion component 172), accounting for inherent processing delays between speech recognition pipeline and vision analytics pipeline. In some embodiments, the audio pipeline component 171 outputs processed audio events (e.g., stored as audio data 120). The audio events can include utterance timing information, transcribed speech text, voice activity metadata, and/or synthesized speech audio streams.

In some embodiments, the audio pipeline component 171 can include or implement one or more ASR engines for speech-to-text conversion. In some embodiments, the ASR engine(s) can process an incoming audio stream during a digital human interaction. In some embodiments, the ASR engine can convert user speech waveforms into text representations for natural language processing. In some embodiments, the ASR engine can be or include an AI model that utilizes neural network architecture trained on speech recognition datasets to identify phonetic patterns and/or linguistic structures. In some embodiments, the ASR engine can generate text transcriptions of user utterances with associated confidence scores and/or timing information. In some embodiments, the ASR engine can be a deep learning model, a convolution neural network a recurrent neural network, a transformer, and/or a hybrid system.

In some embodiments, the ASR engine can include voice activity detection to identify speech segments within audio streams. In some embodiments, the ASR engine can account for varying speech rates, acoustic environments, and speaker characteristics to maintain recognition accuracy. In some embodiments, the ASR engine can operate with measured latencies that include buffering delays and processing time based on utterance length. In some embodiments, the ASR engine can output structured text data that correlates with audio timing information for multimodal sensor fusion with visual engagement metrics. In some embodiments, the text data can be stored as audio data 120. In some embodiments, the text data is transmitted to the avatar control module 165 for further processing.

In some embodiments, the audio pipeline component 171 can include or implement one or more VAD algorithms for detecting speech activity periods within an audio stream (or multiple audio streams). The VAD algorithm can detect when a user is speaking versus not-speaking, and can identify time periods within the audio input that correspond to a user speaking versus not-speaking. The VAD algorithm can enable the audio pipeline component 171 to determine when a user utterance is complete. In some embodiments, the VAD functionality can operate with measured latency of approximately 800 milliseconds.

In some embodiments, the VAD algorithm can generate voice activity metadata that includes timing information and speech detection events. In some embodiments, the VAD algorithm can account for speech rate variations and processing delays in the audio pipeline. In some embodiments, the VAD algorithm output can enable the system to buffer engagement data with precise timestamps for retrospective analysis during speech segments.

In some embodiments, the audio pipeline component 171 can include or implement one or more TTS synthesis AI models for generating human-like speech output for a digital human's conversation turn. In some embodiments, the TTS AI model(s) can convert text input (e.g., from the response generation component 173) into human-like audio output. In some embodiments, the TTS synthesis AI model can generate synthesized speech audio streams as part of processed audio events output by the audio pipeline component 171. In some embodiments, the one or more TTS synthesis AI models are implemented by the speech generation component 174.

In some embodiments, the audio pipeline component 171 can implement configurable audio processing parameters including sampling rates, noise reduction algorithms, and/or speech detection thresholds to optimize performance across different acoustic environments and user interaction scenarios. In some embodiments, the audio pipeline component 171 can generate processed audio events containing utterance timing information, transcribed speech text, voice activity metadata, and/or synthesized speech audio streams. The processed audio events can be stored as audio data 120. The audio events can be transmitted to multimodal fusion component 172 for correlation with contemporaneous visual engagement states. In some embodiments, the audio pipeline component 171 can operate with measured latencies that vary based on utterance length, incorporating delays for VAD, ASR, and/or speech rate calculations to enable accurate temporal synchronization with visual data.

In some embodiments, the engagement and pose analysis module 163 can implement a multimodal fusion component 172 that can combine visual perception data (e.g., as stored in video data 122) with audio processing pipeline data (e.g., as stored in audio data 120). The multimodal fusion component 172 can account for different latency characteristics between vision and speech recognition systems.

In some embodiments, the multimodal fusion component 172 can implement signal processing techniques that normalize audio and video data streams into compatible temporal representations for correlation analysis. In some embodiments, the multimodal fusion component 172 can apply cross-correlation algorithms to identify temporal relationships between speech activity patterns and visual engagement state transitions. In some embodiments, the fusion process can utilize frequency domain analysis to extract relevant spectral components from audio signals that correspond to speech onset and offset timing markers.

In some embodiments, the multimodal fusion component 172 can implement data correlation methods that compute statistical measures of association between audio utterance characteristics and contemporaneous visual engagement metrics. In some embodiments, the multimodal fusion component 172 can apply sliding window correlation analysis to identify temporal alignment between speech segments and engagement measurement periods. In some embodiments, the correlation methods can include confidence-weighted averaging that prioritizes high-confidence landmark detections and speech recognition results during fusion calculations.

In some embodiments, the multimodal fusion component 172 can implement fusion weighting strategies that dynamically adjust the relative importance of audio and visual modalities based on signal quality and detection confidence scores. In some embodiments, the weighting strategies can prioritize visual engagement data when facial landmark confidence scores exceed predetermined thresholds while emphasizing audio timing information when speech recognition confidence is high. In some embodiments, the multimodal fusion component 172 can apply adaptive weighting algorithms that reduce the influence of modalities experiencing signal degradation or processing errors during real-time fusion operations.

In some embodiments, the multimodal fusion component 172 can implement a latency analysis algorithm to account for the different processing delays between the audio pipeline and vision pipeline to enable accurate temporal correlation of user engagement states with speech timing. In some embodiments, the multimodal fusion component 172 can measure and compensate for vision processing latency, which can include the time for the vision pipeline component 170 to process video frames through the AI model and generate pose data, compared to audio processing latency that varies based on utterance length and includes void activity detection (VAD) delays plus automatic speech recognition (ASR) processing time. As an illustrative example, the vision processing delay may be approximately 32 milliseconds, while the audio processing delay may be approximately 800 milliseconds.

In some embodiments, the multimodal fusion component 172 can perform the latency analysis by calculating temporal offset values, e.g., using the following formula: audio_latency=0.26+(number_of_words_in_query)/150 seconds, accounting for speech rate variations and processing delays in the audio pipeline component 171. The multimodal fusion component 172 can apply the calculated latency offset to synchronize engagement metric timestamps with corresponding audio utterance periods, enabling the multimodal fusion component 172 to correlate visual attention data captured during the time window when a user is speaking rather than when the audio processing completed.

In some embodiments, the temporal alignment process can include buffering mechanisms that store engagement data from the vision pipeline component 170 with timestamps, allowing the multimodal fusion component 172 to retrospectively analyze user attention distributions during speech segments once audio processing latencies are resolved. In some embodiments, the buffering mechanisms can maintain a rolling window of visual engagement metrics that corresponds to recent time periods. Using the rolling window of visual engagement metrics, the multimodal fusion component 172 can corelate the visual engagement metric(s) with audio utterances that complete processing after the corresponding visual data has been captured. In some embodiments, the latency compensation can enable the avatar control module 165 to receive synchronized multimodal data that represents the correlation between user speech content and contemporaneous visual engagement states.

In some embodiments, timestamp alignment procedures can correlate engagement metric timestamps with video frame timing and corresponding audio segment boundaries to establish temporal relationships between visual attention states and speech activity periods. In some embodiments, the alignment procedures can account for the difference between when visual engagement data is captured versus when audio transcription results become available, such that the engagement analysis reflects the actual time window during which users were speaking.

In some embodiments, the multimodal fusion component 172 can implement error recovery mechanisms to handle signal degradation and/or processing failures during real-time operations. In some embodiments, the multimodal fusion component 172 can detect signal loss conditions when confidence scores from vision or audio processing fall below predetermined thresholds for extended periods. In some embodiments, the multimodal fusion component 172 can maintain connection stability by implementing protocol negotiation and error recovery mechanisms during extended interaction sessions.

In some embodiments, the multimodal fusion component 172 can manage synchronization failures through adaptive buffering strategies that extend temporal windows when processing delays exceed expected latency parameters. In some embodiments, the multimodal fusion component 172 can recalibrate timestamp alignment procedures when synchronization drift is detected between audio and visual data streams. In some embodiments, the multimodal fusion component can implement fallback synchronization protocols that rely on alternative timing references when primary synchronization methods fail.

In some embodiments, the multimodal fusion component 172 can resolve conflicting modality inputs through confidence-weighted decision algorithms that prioritize data streams with higher reliability scores. In some embodiments, the multimodal fusion component 172 can reduce the influence of modalities experiencing signal degradation while maintaining processing continuity through the remaining functional data streams. In some embodiments, adaptive weighting algorithms can dynamically adjust fusion parameters to compensate for temporary quality degradation in individual modalities without interrupting overall system operation.

In some embodiments, real-time (or near real-time) synchronization protocols can coordinate the flow of engagement data between the vision pipeline component 170 and audio pipeline component 171 to maintain consistent temporal references across both processing streams. In some embodiments, the synchronization protocols can manage the timing of data availability from different pipeline components to align the engagement correlation analysis occurs with temporal windows. In some embodiments, the protocols can enable the multimodal fusion component 172 to access buffered visual engagement data that corresponds to the time intervals when users were actively speaking, rather than when speech processing was completed.

In some embodiments, the multimodal fusion component 172 can apply correlation algorithms to compute statistical measures of association between audio utterance characteristics and contemporaneous visual attention metrics. In some embodiments, the multimodal fusion component 172 can utilize sliding window correlation analysis to identify optimal temporal alignment between speech segments and engagement measurement periods. In some embodiments, the multimodal fusion component 172 can employ cross-correlation algorithms to identify temporal relationships between speech activity patterns and visual engagement state transitions.

In some embodiments, the multimodal fusion component 172 can generate a unified engagement event that combines audio timing information with visual attention classification(s). In some embodiments, the unified engagement event can be stored as engagement data 124. In some embodiments, a unified engagement event can refer to a structured data package that combines temporally synchronized audio timing information with visual attention classification results. In some embodiments, the unified engagement event can include correlation data between user speech segments (e.g., an utterance) and contemporaneous head pose orientation measurements, statistical distributions representing the percentage of time during an utterance that the user maintained engagement above a predetermined threshold, timestamp information that accounts for latency differences between vision and audio processing pipelines, confidence scores associated with visual attention determinations and/or audio activity detection, and/or engagement state classifications indicating whether a user is attentive, distracted, or disengaged during a specific interaction period (e.g., during an utterance). In some embodiments, the unified engagement event can be transmitted to the avatar control module 165.

In some embodiments, the unified engagement event generation can incorporate statistical analysis methods that calculate distributions of user attention states over defined time intervals corresponding to speech episodes. In some embodiments, the statistical analysis can include computation of engagement percentages, variance measurements, and/or confidence intervals for attention state classifications during utterance periods. In some embodiments, frequency domain analysis methods can extract relevant spectral components from audio signals that correspond to speech timing markers for correlation with visual data.

In some embodiments, the multimodal fusion component 172 can implement data weighting techniques that dynamically adjust the relative importance of audio and visual modalities based on signal quality and detection confidence scores. In some embodiments, confidence-weighted averaging can prioritize high-confidence landmark detections and speech recognition results during unified engagement event generation. In some embodiments, adaptive weighting algorithms can reduce the influence of modalities experiencing signal degradation or processing errors during real-time fusion operations.

In some embodiments, the avatar control module 165 can adapt the conversational flow of the digital human based on real-time user engagement analysis. In some embodiments, the avatar control module 165 can receive engagement metrics and/or audio transcription data from engagement pose and analysis module 163. In some embodiments, the avatar control module 165 can process the audio transcription data and engagement metrics by natural language processing models that can interpret user intent and generate contextually appropriate responses. In some embodiments, the avatar control module 165 can include a response generation component 173, a speech generation component 174, and/or an avatar management component 175.

In some embodiments, the response generation component 173 can generate contextually appropriate responses based on a user interaction. In some embodiments, the response generation component 173 can process the audio input and/or the text of the audio input (e.g., generated by audio pipeline component 171) as well as the user engagement metric(s) corresponding to the audio input. For example, the response generation component 73 can receive transcribed speech text from the audio pipeline 171 and visual engagement data from the multimodal fusion component 172.

In some embodiments, the response generation component 173 can include or implement one or more natural language processing (NPL) AI model(s) that can process, interpret, and generate human language in textual or spoken form. An NLP AI system can include one or more machine learning models configured to receive language data and produce contextually relevant output responses. In some embodiments, the model can operate as a sequence-to-sequence system that encodes input text into a latent representation capturing semantic, syntactic, and contextual information, and decodes the representation to generate a corresponding output sequence of tokens. The generated output can include, for example, a direct response, a continuation of the input text, a summary, a translation, or another formal of language-based output. The NLP AI model can employ transformer architectures utilizing self-attention mechanisms to capture dependencies across tokens and maintain contextual coherence throughout the generated sequence. The model may be trained or fine-tuned using large corpora of paired input-output text data and optimized using supervised, unsupervised, or reinforcement learning techniques. In some embodiments, the NLP AI model may further incorporate retrieval mechanisms, dialogue state tracking, or reinforcement-based feedback loops to enhance factual accuracy and conversational relevance. In some embodiments, the models can be trained or fine-tuned using a training dataset that includes engagement metric(s) associate with portions of the text.

In some embodiments, the NPL AI model(s) can be trained or fine-tuned using supervised training using a dataset that correlates textual content with user engagement metrics. The training dataset can include transcribed speech text paired with corresponding engagement metrics, which can indicate whether the user was engaged, distracted, or disengaged during the speech segment corresponding to the transcribed text. The dataset can include statistical distributions representing the percentage of time the user maintained attention above a predetermined threshold during the corresponding speech segment. In some embodiments, the training dataset can include timing metadata that specifies temporal alignment between the text segment and the engagement metric(s). For example, the timing metadata can include start and end timestamps for each speech segment and engagement metrics corresponding to various timestamps within the speech segment. In some embodiments, the training dataset can include appropriate responses for the various engagement metrics. In some embodiments, the NPL AI model(s) can learn to generate contextually appropriate responses based on semantic content and user attention states.

In some embodiments, the response generation component 173 can reference a set of configurable rules that correlate a user engagement metric with an appropriate response strategy. In some embodiments, the response generation component 173 can provide the response strategy as additional context to the NPL AI system. For example, the rules can specify that when a user's engagement metric indicates high user attention (e.g., head orientation within 40 degrees of forward-facing position for over 85% of the utterance duration), the digital human is to maintain standard conversational complexity and response timing. In this example, the response generation component 173 can provide the text of the audio input along with an instruction to maintain standard conversational complexity and response timing to an NPL AI system to generate a response to the user's utterance. Note that in some embodiments, if the user's engagement indicates high user attention, the response generation component 173 can determine to provide the text of the audio input without an additional instruction, as the NPL AI system may by default maintain standard conversational complexity and response timing. Thus, in some embodiments, the response generation component 173 can generate a detailed explanation or comprehensive answer when sustained engagement is detected.

As another example, the rules can specify that when a user's engagement metric indicates moderate or distracted attention (e.g., head orientation within 40 degrees of forward-facing position for between 50% and 85% of the utterance duration), the digital human is to implement an attention-recovery strategy, request clarification of the user's intent, and/or implement temporal buffering. For example, the response generation component 173 can provide the text of the audio input along with an instruction to generate a clarifying question. Examples of the clarifying question include “could you repeat that?” or “Was that question directed to me?” As another example, the response generation component 173 can provide the text of the audio input along with an instruction to implement an attention-recovery strategy, such as including an attention-seeking prompt by asking “are you still with me?” or by stating “you seem distracted. When you're ready, I'm here to help.” As another example, the response generation component 173 can provide the text of the audio input along with an instruction to reduce the complexity and/or timing of the response (e.g., implement temporal buffering by delaying information until user engagement levels improve). In some embodiments, each of these strategies can be associated with a varying degrees of user engagement states. For example, for a minor distracted state (e.g., head orientation within 40 degrees of forward-facing position for between 70% and 85% of the utterance duration), the response generation component 173 can provide instructions to the NPL AI model to generation a clarifying questions; for a moderate distracted state (e.g., head orientation within 40 degrees of forward-facing position for between 60% and 69% of the utterance duration), the response generation component 173 can provide instructions to the NPL AI model to an implement attention-recovery strategy; and for a more severe distracted state (e.g., head orientation within 40 degrees of forward-facing position for between 50% and 59% of the utterance duration), the response generation component 173 can provide instructions to the NPL AI model to implement reduce the complexity of the response.

As another example, the rules can specify that when a user's engagement metric indicates disengaged, such as speaking to a third-party (e.g., head orientation above 60 degrees of forward-facing position for 75% of the utterance duration), the digital human is to ignore (e.g., not respond to) that particular utterance. In some embodiments, the response generation component 173 can determine not to send the text of the utterance to the NPL AI model, thereby saving computing resources when the user is not engaging with the human digital. In some embodiments, the configurable rules enable adaptive response timing, content complexity, and/or conversational strategies based on real-time (or near real-time) engagement analysis. In some embodiments, the response generation component 173 can use the configurable rules to determine the action to be performed by the digital human based on the engagement metric of the corresponding speech segment (e.g., utterance). In some embodiments, the response generation component 173 can store the generated response (e.g., the output of the NPL AI model) as audio data 120, and/or can transmit the generated response to speech generation component 174.

In some embodiments, the speech generation component 174 can receive a textual response from the response generation component 173 and can convert it into synthesized speech audio. In some embodiments, the speech generation component 174 can utilize text-to-speech (TTS) synthesis models that generate human-like vocal output for the digital human. The speech generation component 174 can generate an audio signal that corresponds to the processed text input. In some embodiments, the speech generation component 174 can modulate vocal characteristics such as tone, pace, and/or emphasis based on user engagement metric(s) associated with the corresponding audio input. The speech generation component 174 can apply configurable rules that adjust speech synthesis properties according to attention levels and/or conversational context. For example, the configurable rules can include instructions to moderate the timing of the response (e.g., implement temporal buffering) and/or to adjust the pace of the generated response based on the user engagement metric. For example, if the user engagement metric reflect a severe distracted state (e.g., head orientation within 40 degrees of forward-facing position for between 50% and 59% of the utterance duration), the speech generation component 174 can provide instructions to the speech generation model to slow the delivery of the response or to adjust the tone to regain the user's attention.

In some embodiments, the speech generation component 174 can generate vocal responses for the digital human using the text generated by the speech generation component 174. In some embodiments, the speech generation component 174 can include or implement a speech generation AI model, such as a TTS synthesis model. The speech generation AI model can refer to a computer-implemented system configured to generate audible speech output from textual or symbolic input data. The model may include one or more machine learning components trained to map linguistic features of text to corresponding acoustic features representing human speech. In some implementations, the system may include a text analysis module configured to perform text normalization, tokenization, and linguistic feature extraction, such as phoneme conversion, prosody estimation, and stress pattern identification. The extracted linguistic features may be provided to an acoustic model that predicts intermediate acoustic representations, such as mel-spectrograms or other spectral feature maps, corresponding to the input text. The acoustic representations may then be processed by a vocoder model configured to synthesize a time-domain waveform of the speech signal based on the acoustic features. The acoustic and vocoder models may be implemented using neural network architectures, such as recurrent neural networks (RNNs), convolutional neural networks (CNNs), or transformer-based models employing self-attention mechanisms to capture temporal and contextual dependencies in speech. The model may be trained using paired datasets of text and speech recordings, and optimized using loss functions that measure reconstruction error, perceptual similarity, or prosody consistency. In some embodiments, the speech generation AI model may further incorporate speaker embeddings or style tokens to control speaker identity, emotional tone, or expressive characteristics of the synthesized speech.

In some embodiments, the speech generation component 174 can include or implement one or more TTS synthesis AI models for generating human-like speech output for a digital human's conversation turn. In some embodiments, the TTS synthesis AI model can be or include a neural network that converts text into natural-sounding human speech. The TTS synthesis AI model can be or include a deep learning model, a neural network, a concatenative synthesis model, a diffusion and transformer-based model, a statistical parametric model, a vocoder-based model, a real-time streaming model, an end-to-end deep learning model, and/or a hybrid neural-statistical model, for example. In some embodiments, the TTS AI model(s) can convert text input (e.g., from the response generation component 173) into human-like audio output. In some embodiments, the TTS synthesis AI model can process text responses (e.g., generated by response generation component 173) and generate an audio stream of the text. The generated audio stream can be stored as audio data 120. In some embodiments, the generated audio can be provided, e.g., by the avatar management component 175, to the computing device 102 for presentation to the user through UI 104. In some embodiments, the TTS synthesis AI model can support real-time (or near real-time) speech generation to maintain conversational flow during a digital human interaction. The TTS synthesis processing can enable bidirectional audio communication between a user and the digital human.

In some embodiments, the avatar management component 175 can coordinate the visual animations of the digital human with the generated response. In some embodiments, the avatar management component 175 can receive the generated response and generated audio and can identify response instructions corresponding to the generated response. The response instructions can correspond to the configurable rules corresponding to the user engagement metric. For example, the response instructions can include an instruction to ignore an audio input if the user engagement metric indicates the user is disengaged. As another example, the response instructions can include an instruction to implement an attention-recovery strategy if the user engagement metric indicates the user is distracted. As another example, the response instructions can include an instruction to maintain normal conversational tone and complexity if the user engagement metric indicates the user is engaged and attentive.

In some embodiments, the avatar management component 175 can translate the response instructions into visual avatar control commands. The avatar management component 175 can generate movement instructions that coordinate avatar gestures, facial expressions, and/or body positioning with the synthesized speech audio. In some embodiments, the avatar management component 175 can process the engagement metric data to determine appropriate visual behaviors for the digital human interface.

In some embodiments, the avatar management component 175 can control avatar animation sequences based on user engagement metrics. For example, the avatar management component 175 can generate instructions for head movements, eye gaze direction, and/or facial expressions that correspond to conversational context and user engagement levels. In some embodiments, the avatar management component 175 can synchronize visual animations of the digital human with audio output timing to maintain natural interaction flow.

In some embodiments, the avatar management component 175 can implement configurable animation rules that correlate engagement metrics with specific avatar behaviors. For example, when a user maintains high attention levels, the avatar management component 175 can generate standard conversational gestures and direct eye contact animations. As another example, the avatar management component 175 can modify the behavior of the digital human when engagement metrics indicate distraction, such as generating attention-seeking gestures or pausing animations until user focus returns.

In some embodiments, the avatar management component 175 can output control signals to avatar rendering systems (not pictured) that execute the generated movement instructions. In some embodiments, the avatar management component 175 can maintain state information about current avatar positioning and animation sequences. In some embodiments, the avatar management component 175 can process real-time engagement data to adapt avatar responsiveness and visual attention cues. In some embodiments, the avatar management component 175 can generate instructions for avatar head orientation adjustments that mirror user attention patterns or implement compensatory behaviors to recapture user focus during interactions.

In some embodiments, the avatar control module 165 can generate comprehensive response data that includes synthesized speech audio streams, visual animation control instructions, and/or behavioral coordination parameters. The avatar control module 165 can transmit the response data to computing device 102 via network 140. In some embodiments, the audio and video streaming system 118 can receive the response data from the avatar control module 165 that includes timing synchronization information that correlates vocal responses with corresponding avatar animations, facial expressions, and gesture sequences. In some embodiments, the computing device 102 processes these instructions through the application 117 to coordinate audio playback with visual avatar rendering. In some embodiments, the user interface 104 can display the avatar's response by executing the received visual animation instructions while simultaneously playing the synthesized speech audio through connected speakers or audio output devices. The UI 104 renders avatar movements, facial expressions, and behavioral responses that have been adapted based on the user's engagement metrics and attention states analyzed during the interaction session. The avatar's response presentation on UI 104 can maintain temporal alignment between visual animations and vocal output to provide natural conversational flow.

In some embodiments, server device 160 can include one or more graphics processing units (GPU) 161. In some embodiments, the GPU 161 can be used by the digital human interaction system 162 for speech and/or video analysis, and/or to generate and/or manage the digital human.

In some embodiments, one or more GPU(s) 161 can provide accelerated processing capabilities for real-time (or near real-time) speech analysis operations including automatic speech recognition and/or text-to-speech synthesis within the digital human interaction system 162. In some embodiments, one or more GPU(s) 161 can perform high-performance video analysis tasks such as pose detection, facial landmark identification, and/or engagement metric calculations from incoming video streams. In some embodiments, one or more GPU(s) 161 can execute machine learning models for body pose estimation and head orientation analysis to determine user attention states during interactions with the digital human.

In some embodiments, one or more GPU(s) 161 can generate and render three-dimensional digital avatars with synchronized facial animations and/or gesture coordination based on processed audio and engagement data. In some embodiments, the server device 160 can utilize one or more GPU(s) 161 for processing by an audio-driven 3D facial animation generation system that creates facial animation data from streaming audio responses. In some embodiments, one or more GPU(s) 161 can support real-time (or near real-time) avatar rendering operations including animation graph processing and visual effect generation for natural digital human presentations.

In some embodiments, the server device 160 can implement a distributed architecture with multiple processing pipelines that leverage GPU acceleration for parallel processing of multimodal interaction data. In some embodiments, the system can utilize GPU-optimized software frameworks for executing containerized applications that handle speech processing, computer vision analysis, and/or avatar animation generation. In some embodiments, the server device 160 can coordinate GPU resources across different microservices including multimodal conversational-agent orchestration controller pipelines, animation processing components, and/or rendering systems to maintain real-time (or near real-time) interaction performance.

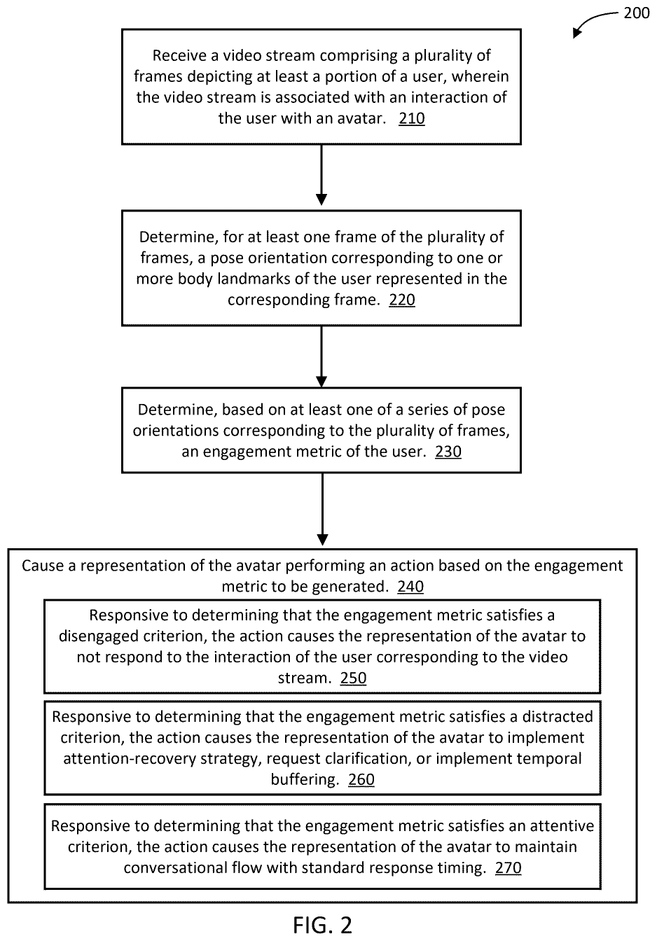

The digital human interaction system 162 is further described with respect to FIGS. 2-4.

In some embodiments, computing device 102 can include a memory 112 (e.g., one or more memory devices or units) communicatively coupled to one or more processing devices, such as one or more central processing units (CPU) 114, one or more graphics processing units (GPU) (not pictured), one or more data processing units (DPU), one or more parallel processing units (PPUs), and/or other processing devices (e.g., field-programmable gate arrays (FPGAs), application-specific integrated circuits (ASICs), and/or the like). Memory 112 may include a read-only memory (ROM), a flash memory, a dynamic random-access memory (DRAM), such as synchronous DRAM (SDRAM), a static memory, such as static random-access memory (SRAM), and/or some other memory capable of storing digital data.

FIG. 1 is an example architecture of a computing system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

FIG. 2 is a flow diagram of an example method 200 for determining an engagement metric of a user during an interaction with a digital human, according to at least one embodiment. In at least one embodiment, method 200 may be performed using processing units of computing device 102 and/or of server device 160 of FIG. 1. In at least one embodiment, processing units performing method 200 may be executing instructions stored on a non-transient computer-readable storage media. In at least one embodiment, method 200 may be performed using multiple processing threads (e.g., CPU threads and/or GPU threads), with individual threads executing one or more individual functions, routines, subroutines, or operations of the methods. In at least one embodiment, processing threads implementing method 200 may be synchronized (e.g., using semaphores, critical sections, and/or other thread synchronization mechanisms). Alternatively, processing threads implementing method 200 may be executed asynchronously with respect to each other. Various operations of method 200 may be performed in a different order compared with the order shown in FIG. 2. Some operations of method 200 may be performed concurrently with other operations. In at least one embodiment, one or more operations shown in FIG. 2 may not always be performed.

Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method may additionally or alternatively be executed by any one system, or any combination of systems, including, but not limited to, those described herein.

At block 210, processing logic may receive a video stream. The video stream can include a plurality of frames depicting at least a portion of a user. The video stream can be associated with an interaction of the user with an avatar (e.g., a digital human). In some embodiments, the video stream may be transmitted from computing device 102 to server device 160 via network 140 of FIG. 1, e.g., using webRTC protocol or RTSP.

At block 220, processing logic 200 may determine, for at least one frame of the plurality of frames of the video stream of the user, a pose orientation that corresponds to one or more body landmarks of the user represented in the corresponding frame. In some embodiments, the method 200 may identify the one or more body landmarks by providing each frame of the at least one frame of the plurality of frames to a machine learning model trained to output a set of coordinates (e.g., 2D or 3D coordinates) for a corresponding body landmark. The coordinate may be output with a corresponding confidence score in embodiments. In some embodiments, the processing logic determines whether the confidence score of at least one of the one or more body landmarks of a corresponding frame exceeds a threshold value, and includes the pose orientation of the corresponding frame in the series of pose orientations used to determine the engagement metric at block 230. In some embodiments, the at least one pose orientation of the one or more pose orientations can represent rotational parameters of a head of the user, such as yaw, pitch, and roll angles.

At block 230, processing logic may determine, based on at least one of a series of pose orientations corresponding to the plurality of frames, an engagement metric of the user. In some embodiments, processing logic can apply an exponential weighted average on the series of pose orientations corresponding to the plurality of frames to smooth one or more user movement across the series of pose orientations.

At block 240, processing logic may cause a representation of the avatar performing an action based on the engagement metric to be generated. In some embodiments, to determine the engagement metric of the user, processing logic can compare the at least one pose orientation of the series of pose orientations to a predetermined user engagement condition. The user engagement metric can correspond to a result of the comparison. In some embodiments, the predetermined user engagement condition may include angular threshold values for head pose orientation, such as determining that a user is engaged when pose (e.g. head) orientation is within 40 degrees of forward-facing position, distracted when pose (e.g., head) orientation fall between 40 and 60 degrees, and disengaged when pose (e.g., head) orientation exceeds 60 degrees from the digital human interface.

In some embodiments, the engagement metric can include timestamp information, confidence scores, and/or an engagement state classification (e.g., engaged or attentive, distracted, or disengaged). In some embodiments, the threshold condition can include a temporal aspect, such as maintain a specific engagement level for a predetermined duration before sending the engagement metric to the system controlling the avatar. In some embodiments, the method 200 can apply exponential smoothing algorithms to the engagement metric calculations (e.g., as described with respect to block 230) to reduce false alerts caused by momentary head movements while preserving sensitivity to genuine attention state transitions. In some embodiments, the engagement metric can include statistical disruptions representing the percentage of time during corresponding audio utterances that the user maintained above configurable engagement thresholds, enabling the system controlling the avatar to correlate visual engagement with speech timing for dialogue management determinations.

In some embodiments, processing logic can include identifying an audio stream corresponding to the video stream, and determining speech timing data of the audio stream. The method 200 can include determining a correlation between the series of poses corresponding to the plurality of frames and the speech timing data of the audio stream. The engagement metric of the user is further based on the correlation in some embodiments.

In some embodiments, processing logic can determine an audio processing latency based on an utterance length of the audio stream and a voice activity detection delay associated with the audio stream. In some embodiments, the audio processing latency calculation can account for multiple processing delays within the audio pipeline component 171. In some embodiments, the utterance length can be determined by measuring the duration between speech onset and offset detected through voice activity detection algorithms. In some embodiments, the voice activity detection delay can include buffering time required to identify when users have completed speaking before initiating automatic speech recognition processing.

In some embodiments, the audio processing latency can be calculated using a formula that incorporates both fixed processing delays and variable delays based on speech characteristics. In some embodiments, the latency calculation can include automatic speech recognition processing time that varies according to the complexity and length of user utterances.

In some embodiments, processing logic can align a timestamp of the engagement metric with a portion of the audio stream corresponding to the utterance length using the audio processing latency to fuse the engagement metric with the speech timing data of the audio stream. In some embodiments, the timestamp alignment process can compensate for the temporal offset between when visual engagement data is captured and when corresponding audio transcription results become available.

In some embodiments, the alignment of engagement metric timestamps can enable correlation of visual attention states with the actual time periods during which users were speaking rather than when audio processing was completed. In some embodiments, the temporal alignment can facilitate accurate determination of user engagement levels throughout the duration of specific speech episodes. In some embodiments, the synchronized timestamps can enable the multimodal fusion component to generate statistical distributions representing user attention percentages during corresponding audio utterances.

In some embodiments, processing logic can include determining a statistical distribution of the series of poses corresponding to the audio stream. The processing logic can further include determining, based on the statistical distribution, a percentage of time during the audio stream that the engagement metric satisfies a threshold. The engagement metric corresponds to the percentage of time in some embodiments.

In some embodiments, at block 250, responsive to determining that the engagement metric satisfies a disengaged criterion, the action causes the representation of the avatar to not respond to the interaction of the user corresponding to the video stream. For example, the processing logic can determine not to process the audio stream and/or the video stream and to cause the avatar to maintain a neutral stance and/or neutral facial expression. In some embodiments, the action that causes the avatar to ignore the interaction can be correlated with timing information of the video stream and/or audio stream.

In some embodiments, at block 260, responsive to determining that the engagement metric satisfies a distracted criterion, the action causes the representation of the avatar to (1) request clarification regarding an intent of the user behind the interaction, (2) implement an attention-recovery strategy conversation, and/or (3) implement temporal buffering by delaying information until user engagement levels improve. For example, processing logic can identify a response strategy that corresponds to the engagement metric (e.g., based on configurable rules as described with respect to FIG. 1). Processing logic can determine the action by providing the audio stream and/or video stream and the response strategy to one or more AI models (e.g., as described with respect to the digital human interaction system 162 of FIG. 1) to generate an appropriate response to the audio stream. In some embodiments, processing logic can provide audio event data, including for example utterance timing information, transcribed speech text, voice activity metadata, along with the response strategy to the one or more AI models to generate an appropriate response to the audio stream. The processing logic can cause the response to be presented on the user device.

In some embodiments, at block 270, responsive to determining that the engagement metric satisfies an attentive criterion, the action causes the representation of the avatar to maintain conversational flow with a standard response timing. For example, processing logic can provide the audio stream and/or video stream to one or more one or more AI models (e.g., as described with respect to the digital human interaction system 162 of FIG. 1) to generate an appropriate response to the audio stream. In some embodiments, processing logic can provide audio event data, including for example utterance timing information, transcribed speech text, voice activity metadata, along with the response strategy to the one or more AI models to generate an appropriate response to the audio stream. The processing logic can cause the response to be presented on the user device.

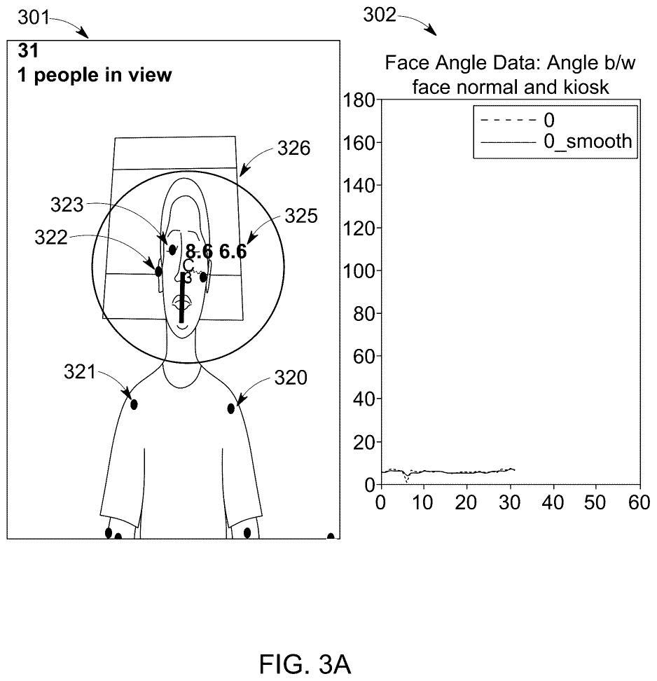

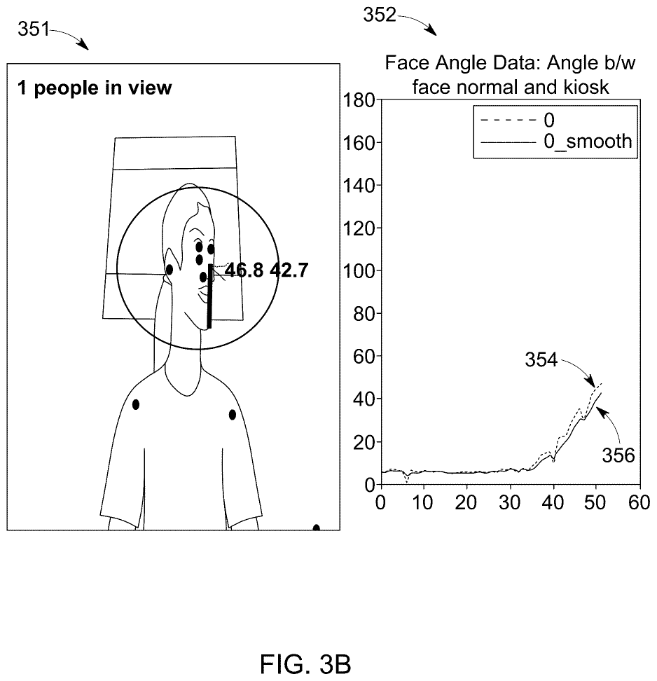

FIGS. 3A and 3B illustrate examples of video frame 301 and 351 and graph 302 and 352 showing face angle measurements over time, according to at least one embodiment. Graphs 302 and 352 track the user's head orientation over a particular time period, e.g., during an interaction with a digital human. Graphs 302 and 352 display angle measurements (along the y-axis) plotted again time units (along the x-axis). The y-axis represents face angle values ranging from approximately 0 to 180 degrees, and the x-axis represents time progression from 0 to approximately 60 units (e.g., 60 seconds).

In some embodiments, graphs 302 and 352 can display two data lines. For example, as illustrated in FIG. 3B, data line 354 represents the raw angle measurements, and data line 356 represents the smoothed angle measurements. In some embodiments, the raw angle measurements can be smoothed using exponential weighted averaging applies to reduce jitter and/or noise in real-time (or near real-time) pose tracking. The smoothed data line 356 shows reduced fluctuations compared to the raw data line 354, which can help the engagement and pose analysis module 163 stabilize face angle calculations to provide reliable engagement analysis. Both data lines 354 and 356 follow similar trajectory patterns but the smoothed data line 306 exhibits less variation, demonstrating the system's capability to filter out momentary detection inconsistencies while maintaining responsiveness to genuine changes in user head orientation. Graphs 302 and 352 represent a visualization of the type of pose data 126 that can be generated and/or use by the engagement and pose analysis module 163 to determine user attention levels and engagement metrics during digital human interactions (e.g., as determined at block 230 of FIG. 2).

The video frames 301 and 351 illustrate images of a user captured by a camera (e.g., a webcam) during an interaction with a digital human. As illustrated in FIG. 3A, the video frame 301 includes several identified landmarks, including, for example, shoulder landmarks 320, 321, an ear landmark 322, an eye landmark 323, and coordinate data 325. The landmarks 320-323 and and coordinate data 325 represent real-time landmark detection and pose estimation performed by the engagement and pose analysis module 163. The image also includes a circle 326 around the user's face. In some embodiments, the circle 326 can correspond the bounding box or bounding shape described with respect to FIG. 1. In some embodiments, the circle 326 can represent the region of interest for which the engagement and pose analysis module 163 can perform facial landmark detection and head pose estimation calculations. In some embodiments, the circle 326 can represent a visual indicator of the facial bounding box or bounding shape described with respect FIG. 1, where the engagement and pose analysis module 163 determines the area containing detected facial landmarks with confidence scores that satisfy a criterion (e.g., exceed a confidence threshold). In some embodiments, within the circle 326, the engagement and pose analysis module 163 can identify and track facial landmarks (e.g., nose, eyes, and/or ears, as shown by landmarks 323 and 322) that are used for calculating 3D head orientation angles. In some embodiments, circle 326 can represent the active detection zone in which the engagement and pose analysis module 163 monitors user attention and engagement levels. In some embodiments, when the user's face is oriented toward and contained within circle 326, as shown in FIG. 3A, the engagement and pose analysis module 163 can determine that the user is engaged and paying attention to the digital human interaction. The engagement and pose analysis module 163 can maintain continuous tracking of the facial region throughout the interaction session. In some embodiments, the circle 326 can be a square or any other appropriate shape.

In some embodiments, the engagement and pose analysis module 163 can determine that a user is engaged if the user's face is pointing toward the circle 326, e.g., as illustrated in FIG. 3A. In some embodiments, the engagement and pose analysis module 163 can determine that the user is disengaged and/or distracted if the angle (e.g., plotted on graph 302 and/or 352) is greater than 40 degrees. For example, the engagement and pose analysis module 163 can determine the user illustrated in image frame 351 of FIG. 3B is distracted at around the 50 unit time mark, when the angle exceeds 40 degrees. In contrast, FIG. 3A shows a user who is engaged.

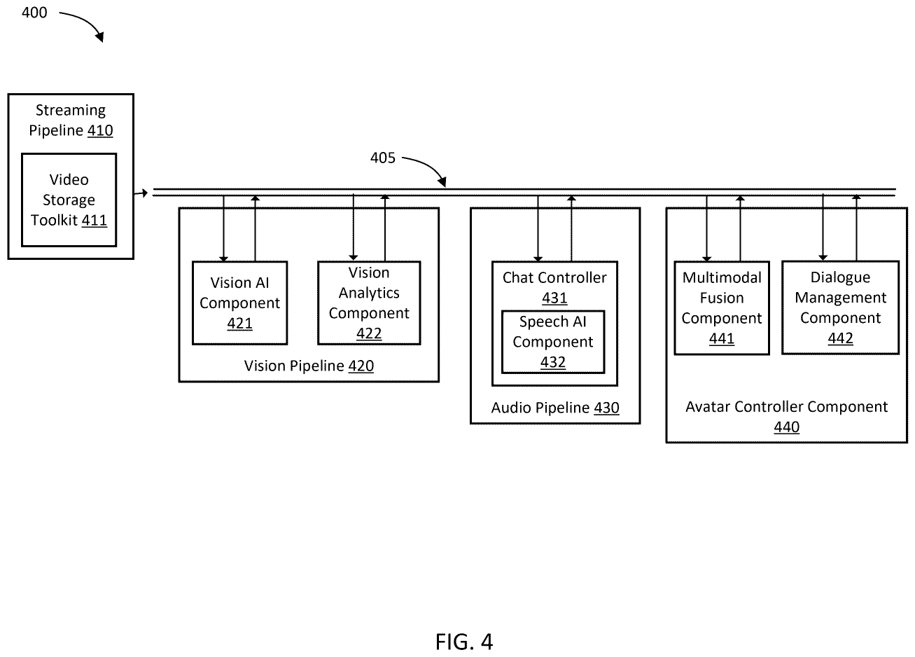

FIG. 4 illustrates a block diagram of an example multimodal interaction system architecture 400, according to at least one embodiment. The system architecture 400 includes a streaming pipeline 410, a vision pipeline 420, an audio pipeline 430, and an avatar controller component 440 connected by a message bus 405. In some embodiments, the architecture 400 can implement a distributed, event-driven workflow coordinated by a message bus and stream lifecycle events.

In some embodiments, the streaming pipeline 410 can perform the same (or similar) functions as the audio and video streaming system 118 of FIG. 1. The streaming pipeline 410 can implement or support bidirectional streaming with a web client (e.g., a web browser or kiosk) that provides the digital human interaction to a user of a user device (e.g., computing device 102 of FIG. 1). In some embodiments, a streaming pipeline can use WebRTC for media transport and a WebSocket channel for signaling. In some embodiments, the streaming pipeline 410 can include a video storage toolkit 411. In some embodiments, a TURN server (e.g., coturn) can facilitate network address translation (NAT) traversal between a web UI and the video storage toolkit 411. The video storage toolkit 411 can be a video management system that manages audio and/or video streams, and that can provide on-demand access to offline streams from storage. In some embodiments, the video storage toolkit 411 can receive video and/or audio streams, e.g., from audio-video input 108 and/or directly from UI 104 of FIG. 1. In some embodiments, the video and/or audio stream can be a WebRTC stream. The video storage toolkit 411 can output a video and/or audio stream (e.g., an RTSP stream) for further processing. For example, the video storage toolkit 411 can generate a stream event, and can transmit the stream event to message bus 405 for further processing. In some embodiments, the video storage toolkit 411 can issue a message on client connect and can assign a unique streamID for downstream routing. In some embodiments, a stream workload distribution and routing module (not pictured) can route the streamID to available pods for vision pipeline 420, audio pipeline 430, avatar controller component 440, an animation graph (not pictured), and/or a real-time 3D content creation platform (not pictured) to achieve GPU-level scaling. In some embodiments, the real-time 3D content creation platform can stream avatar video frames to the web UI using pixel streaming.

In some embodiments, the video storage toolkit 411 can be responsible for streaming out avatar animation stream(s), e.g., to UI 104 of FIG. 1. In some embodiments, the video storage toolkit 411 can manage the stream quality suitable for a current available bandwidth. In some embodiments, the input to video storage toolkit 411 can be an audio and/or video stream (e.g., from a browser client) and rendered avatar stream, such as an avatar user datagram protocol (UDP) stream. In some embodiments, the output of video storage toolkit 411 can be the rendered avatar stream (e.g., provided for presentation on UI 104 of FIG. 1), a stream to a chat controller and/or video controller (e.g., an RTSP stream), and/or a notification to downstream services (e.g., pipelines 420, 430, 440) to notify about new streaming sessions. The notification can be or include the stream event that is transmitted to the message bus 405 for processing. In some embodiments, the stream event can be or include an RTSP stream of a user's interaction with an avatar. In some embodiments, the stream event can include one or more video frames and corresponding audio of a user's interaction with an avatar.

In some embodiments, the message bus 405 connecting the vision pipeline 420, the audio pipeline 430, and the avatar controller component 440 can be implemented by server device 160. In some embodiments, the vision pipeline 420 can perform the same (or similar) functions as the vision pipeline component 170 of FIG. 1, and can include a vision AI component 421 and/or a vision analytics component 422. In some embodiments, the vision AI component 421 can receive a RTSP stream and/or the video frame(s) of the user's interactions with the avatar (e.g., as part of the stream event from the streaming pipeline 410). The vision AI component 421 can be or include an AI model that is trained to detect body poses from an image and/or video stream. In some embodiments, the AI model can be a pose-detection model that can provide estimated of a number of landmarks of a person's body from an image or video stream. In some embodiments, the landmarks can include, for example, the nose, eyes, ears, shoulders, elbows, wrists, hips, knees, ankles, and so on. In some embodiments, the AI model can be or include a computer vision neural network that processes individual video frames and outputs structured coordinate data for each detected landmark.

In some embodiments, the computer vision AI model can perceive, interpret, and extract information from visual data, such as digital image frames or video sequences. The computer vision AI model can employ one or more machine learning models, such as convolutional neural networks (CNNs), recurrent neural networks (RNNs), vision transformers (ViTs), or hybrid architectures, to analyze pixel-level patterns and infer semantic representations of the visual content. The computer vision AI model can include an image preprocessing module configured to perform normalization, resizing, noise reduction, or data augmentation to improve the quality and consistency of the input data. Feature extraction layers of the AI model can process the preprocessed image data to generate hierarchical feature maps that capture spatial, structural, and contextual attributes of the scene. Based on these features, the AI model can perform one or more vision-related tasks, such as object detection, image classification, segmentation, keypoint estimation, scene understanding, depth estimation, or optical flow prediction. In some implementations, the computer vision AI system can employ attention mechanisms to capture long-range dependencies across image regions, thereby improving the accuracy of visual inference. The AI model can be trained using large-scale datasets of labeled or unlabeled images and optimized using supervised, semi-supervised, or self-supervised learning techniques to enhance generalization and robustness under varying environmental conditions.

The AI model can output a set of coordinates (e.g., x, y values) that specify the pixel location of each detected landmark within an image frame. The AI model can also provide a confidence score corresponding to the set of x-y coordinates for each landmark. In some embodiments, the x-y coordinates and the corresponding confidence score can be stored in landmark data 125 of FIG. 1. The vision AI component 421 can generate and output to the message bus 405 a vision event that includes the detected landmark data (including the corresponding confidence score(s)), corresponding temporal indicators for each identified landmark, and/or any other data provided by the vision AI model.

In some embodiments, the vision analytics component 422 of the vision pipeline 420 can receive a stream event from message bus 405. In some embodiments, the vision analytics component 422 can implement a pose estimation algorithm to determine a pose of the user for each frame of the video stream. In some embodiments, the pose estimation algorithm can be a perspective-n-point (PnP) pose algorithm. In some embodiments, the vision analytics component 422 can perform a smoothing on the determined poses, e.g., by determining an exponential weighted average to reduce jitter. In some embodiments, the determined poses can be stored as pose data 126 of data store 150 of FIG. 1.

In some embodiments, the vision analytics component 422 can be or include an event-driven, microservices-based architecture that provides video analysis. The vision analytics component 422 can ingest a video stream (e.g., from the video storage toolkit 411 via message bus 405), and can detect and/or track the user in real-time (or near real-time), e.g., using an AI perception service. The AI perception service can generate metadata that captures key information about the user detected in the video stream. Using the metadata, the video analytics component 422 can perform spatio-temporal analysis of the user's movements and/or behavior.

In some embodiments, the vision analytics component 422 can provide insights, such as time-series metrics and/or alerts based on custom rules. In some embodiments, the vision analytics component 422 can determine a user's engagement level based on a pose or a series of poses. In some embodiments, the user's engagement level can be classified into one of multiple states, such as attentive, distracted, or disengaged. It should be noted that fewer or additional states may be used. The user's engagement level can be classified into one of multiple states based on customizable rules. For example, when a user's head orientation remains within a below a predefined value (e.g., 40 degrees or less), the vision analytics component 422 can classify the user as attentive or engaged. As another example, when the user's head orientation exceeds a predefined value (e.g., is over 60 degrees), the vision analytics component 422 can classify the user as disengaged or looking away from the digital human interface. As another example, when the user's head orientation is within a predefined angular range (e.g., between 40 and 60 degrees of direct forward-facing position), the vision analytics component 422 can classify the user as distracted. In some embodiments, the user's engagement levels and/or engagement metrics can be stored as engagement data 124 of data store 150 of FIG. 1.

In some embodiments, the vision analytics component 422 can output, to the message bus 405, a vision analytics event that includes the detected poses, the engagement metric(s), and/or any other relevant information determined by the vision analytics component 422. In some embodiments, the vision analytics component 422 can output a vision analytics event based on the user's level of attention. In some embodiments, the vision analytics component 422 can generate an alert (e.g., a vision analytics event) based on customizable rules. In some embodiments, the customizable rules can include, for example, temporal engagement thresholds that trigger notifications when user attention levels fall below a specified percentage during a defined time window. As an illustrative example, the customizable rule can include a rule that triggers a notification when a user maintains less than 70% engagement during a 10-second speech utterance. For example, if the engagement metric satisfies a criterion indicating that the user is paying attention (e.g., if the engagement metric is above a certain value), the vision analytics component 422 can determine not to send a vision analytics event. However, if the engagement metric satisfies a criterion indicating that the user is not paying attention (e.g., if the engagement metric is below a certain value), the vision analytics component 422 can determine to send a vision analytics event. In some embodiments, the vision analytics component 422 can output a vision analytics event whether the user is determined to be paying attention or not.

In some embodiments, the audio pipeline 430 can receive and process audio streams, e.g., from user devices (e.g., computing device 102 of FIG. 1), to enable speech recognition and/or synthesis capabilities for digital human interactions. In some embodiments, the audio pipeline 430 can perform the same (or similar) functions as the audio pipeline component 171 of FIG. 1. The audio pipeline 430 can include a chat controller 431 that manages conversational flow and coordinates audio processing operations with other system components via the message bus 405. The chat controller 431 can include or implement a speech AI component 432 that can implement one or more speech AI models, including, for example, automatic speech recognition, text-to-speech synthesis, and/or natural language processing. In some embodiments, the chat controller 431 can implement voice activity detection (VAD) algorithms to identify when a user is speaking versus silent. The chat controller 431 can determine when a user has stopped talking, which can be used to determine when an utterance (or a particular interaction session with the digital human) is complete. This determination can enable correlation of speech timing with visual engagement for multimodal sensor fusion.

In some embodiments, the audio pipeline 430 can incorporate a speech AI component 432 that can implement automatic speech recognition (ASR) and test-to-speech (TTS) synthesis. The speech AI component 432 can convert user audio utterances into text for natural language processing. The speech AI component 432 can generate synthesized speech responses from digital human generation system. In some embodiments, the synthesized audio can be provided to an audio-driven 3D facial animation generation system to generate facial animation data. In some embodiments, the audio pipeline 430 can include buffering mechanisms to manage temporal alignment between audio processing latencies and visual perception data, accounting for different processing delays between speech recognition and computer vision pipelines.

The audio pipeline 430 can receive a RTSP stream and/or the video frame(s) of the user's interactions with the avatar (e.g., as part of the stream event from the streaming pipeline 410). The audio pipeline 430 can generate a speech event that includes processed audio data, utterance timing information, and/or speech recognition results. The audio pipeline 430 can transmit the speech event to message bus 405. In some embodiments, the audio pipeline 43 can implement configurable audio processing parameters including sampling rates, noise reduction algorithms, and/or speech detection thresholds to optimize performance across different acoustic environments and user interaction scenarios.

In some embodiments, the avatar controller component 440 can serve as the central coordination system that integrates multimodal sensor data to control digital human responses and behavior. In some embodiments, the avatar controller component 440 can connect to video storage toolkit 411 to receive live audio input and can orchestrate response generation. In some embodiments, the avatar controller component 440 can implement real-time voice and/or multimodal conversational agent framework, and/or can integrate with external knowledge sources.

In some embodiments, the multimodal fusion component 441 can receive processed data events from the vision pipeline 420 and/or the audio pipeline 430 via message bus 405. In some embodiments, the avatar controller component 440 can include a multimodal fusion component 441 and/or a dialogue management component 442. In some embodiments, the multimodal fusion component 441 can perform the same (or similar) functions as the multimodal fusion component 172. In some embodiments, the dialogue management component 442 can perform the same (or similar) functions as the avatar management component 175 of FIG. 1.

In some embodiments, the multimodal fusion component 441 can synchronize visual perception data from the vision pipeline 420 with audio processing data from the audio pipeline 430. The multimodal fusion component 441 can account for different latency characteristics between vision and speech recognition systems. In some embodiments, the multimodal fusion component 441 can include data integration system configured to synchronize and correlate visual perception data from vision pipeline 420 with audio processing data from audio pipeline 430. The multimodal fusion component 441 can account for inherent latency differences between computer vision and speech recognition processing pipelines. The multimodal fusion component 441 can include temporal alignment algorithms that buffer and time-stamp incoming data streams to enable correlation of user speech timing with contemporaneous visual engagement states throughout the duration of a user's utterance. In some embodiments, the multimodal fusion component 441 can generate a unified engagement event that combines audio timing information with visual attention classification(s). The multimodal fusion component 441 can transmit the unified engagement event(s) to the dialogue management component 442 for adaptive conversational control.

In some embodiments, the avatar controller component 440 can be configured to avoid cross-talk by classifying whether an utterance is directed to the avatar based on temporally aligned engagement signals. In some embodiments, the multimodal fusion component 441 can compute a statistical distribution of the user's engagement state (e.g., a percentage of time the engagement metric satisfies a threshold) and output, with the unified engagement event, a directed/undirected classification. The dialogue management component 442 can generate a response based on this classification, including, for example, suppressing or delaying a response when the engagement percentage falls below a configurable threshold (e.g., the utterance is likely address to a bystander), issuing a clarification prompt when partial engagement is detected, or proceeding normally when engagement criteria are met. In some embodiments, in multi-user scenarios, per-use pose tracks and engagement metrics are maintained. The multimodal fusion component 441 can evaluate candidate tracks against the utterance interval to identify the most plausible addressee and marks utterances as indeterminate when engagement evidence is insufficient (e.g., inadequate facial landmarks or low confidence), thereby preventing erroneous responses during simultaneous or overlapping speech.

In some embodiments, the dialogue management component 442 can adapt conversational flow based on real-time (or near real-time) engagement analysis received from the multimodal fusion component 441. For example, when a user is determined to be actively engaged, the dialogue management component 442 can maintain standard response timing and conversational complexity. When a user is determined to be disengaged or distracted, the dialogue management component 442 can implement attention-recovery strategies, request clarification regarding user intent, ignore inputs not directed at the digital human, and/or implement temporal buffering to delay information until engagement levels improve.

In some embodiments, the avatar controller component 440 can provide the audio and animation cues to an animation graph together with gesture triggers based on the user's engagement metrics. In some embodiments, the animation graph can compose final animation sequences and can send animation outputs and synchronized audio to the real-time 3D content creation platform. In some embodiments, the real-time 3D content creation platform can render the avatar with the received animation and can stream the resulting video to the web UI. In some embodiments, the avatar controller component 440 can maintain a WebSocket connection to the web UI to send transcripts, tables, and/or images alongside the avatar stream. In some embodiments, this workflow can align the controller, animation, and rendering stages with the streaming path to reduce latency and to support scalable, multimodal interactions.

### Inference and Training Logic

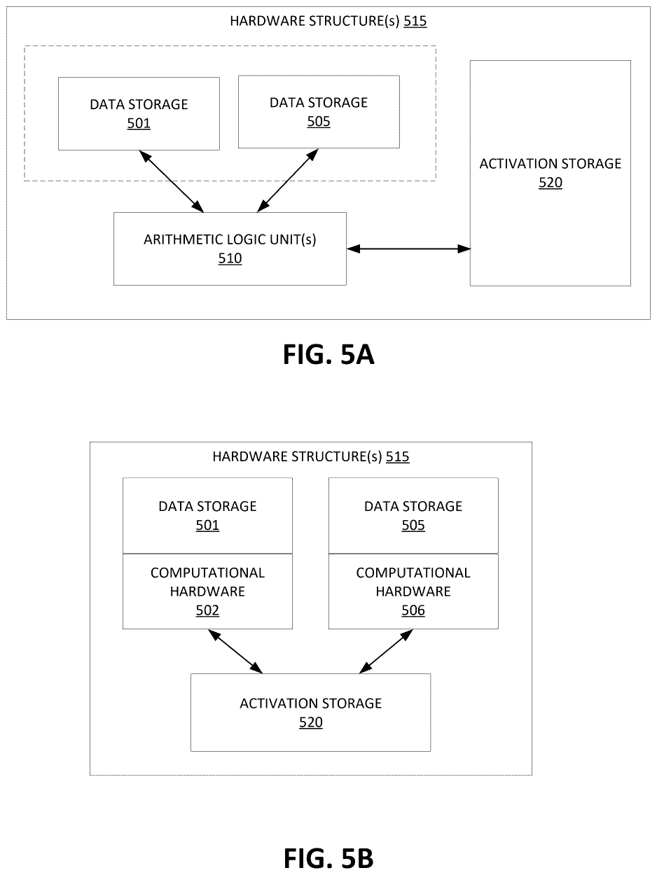

FIG. 5A illustrates inference and/or training logic 515 used to perform inferencing and/or training operations associated with one or more embodiments, such as with regards to an artificial intelligence (AI) model that generates anatomical landmarks, or with regards to speech AI models (e.g., speech recognition or text-to-speech synthesis model). Details regarding inference and/or training logic 515 are provided below in conjunction with FIGS. 5A and/or 5B.

In at least one embodiment, inference and/or training logic 515 may include, without limitation, code and/or data storage 501 to store forward and/or output weight and/or input/output data, and/or other parameters to configure neurons or layers of a neural network trained and/or used for inferencing in aspects of one or more embodiments. In at least one embodiment, training logic 515 may include, or be coupled to code and/or data storage 501 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 501 may be included with other on-chip or off-chip data storage, including a processor's L1, L2, or L3 cache or system memory.

In at least one embodiment, any portion of code and/or data storage 501 may be internal or external to one or more processors or other hardware logic devices or circuits. In at least one embodiment, code and/or code and/or data storage 501 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a code and/or data storage 505 to store backward and/or output weight and/or input/output data corresponding to neurons or layers of a neural network trained and/or used for inferencing in aspects of one or more embodiments. In at least one embodiment, code and/or data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 515 may include, or be coupled to code and/or data storage 505 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 505 may be included with other on-chip or off-chip data storage, including a processor's L1, L2, or L3 cache or system memory. In at least one embodiment, any portion of code and/or data storage 505 may be internal or external to on one or more processors or other hardware logic devices or circuits. In at least one embodiment, code and/or data storage 505 may be cache memory, DRAM, SRAM, non-volatile memory (e.g., Flash memory), or other storage. In at least one embodiment, choice of whether code and/or data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 501 and code and/or data storage 505 may be separate storage structures. In at least one embodiment, code and/or data storage 501 and code and/or data storage 505 may be same storage structure. In at least one embodiment, code and/or data storage 501 and code and/or data storage 505 may be partially same storage structure and partially separate storage structures. In at least one embodiment, any portion of code and/or data storage 501 and code and/or data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 520 that are functions of input/output and/or weight parameter data stored in code and/or data storage 501 and/or code and/or data storage 505. In at least one embodiment, activations stored in activation storage 520 are generated according to linear algebraic and or matrix-based mathematics performed by ALU(s) 510 in response to performing instructions or other code, wherein weight values stored in code and/or data storage 505 and/or code and/or data storage 501 are used as operands along with other values, such as bias values, gradient information, momentum values, or other parameters or hyperparameters, any or all of which may be stored in code and/or data storage 505 or code and/or data storage 501 or another storage on or off-chip.

In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 501, code and/or data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as data processing unit (“DPU”) hardware, or field programmable gate arrays (“FPGAs”).

FIG. 5B illustrates inference and/or training logic 515, according to at least one or more embodiments. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as data processing unit (“DPU”) hardware, or field programmable gate arrays (FPGAs). In at least one embodiment, inference and/or training logic 515 includes, without limitation, code and/or data storage 501 and code and/or data storage 505, which may be used to store code (e.g., graph code), weight values and/or other information, including bias values, gradient information, momentum values, and/or other parameter or hyperparameter information. In at least one embodiment illustrated in FIG. 5B, each of code and/or data storage 501 and code and/or data storage 505 is associated with a dedicated computational resource, such as computational hardware 502 and computational hardware 506, respectively. In at least one embodiment, each of computational hardware 502 and computational hardware 506 comprises one or more ALUs that perform mathematical functions, such as linear algebraic functions, only on information stored in code and/or data storage 501 and code and/or data storage 505, respectively, result of which is stored in activation storage 520.

In at least one embodiment, each of code and/or data storage 501 and 505 and corresponding computational hardware 502 and 506, respectively, correspond to different layers of a neural network, such that resulting activation from one “storage/computational pair 501/502” of code and/or data storage 501 and computational hardware 502 is provided as an input to “storage/computational pair 505/506” of code and/or data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Data Center

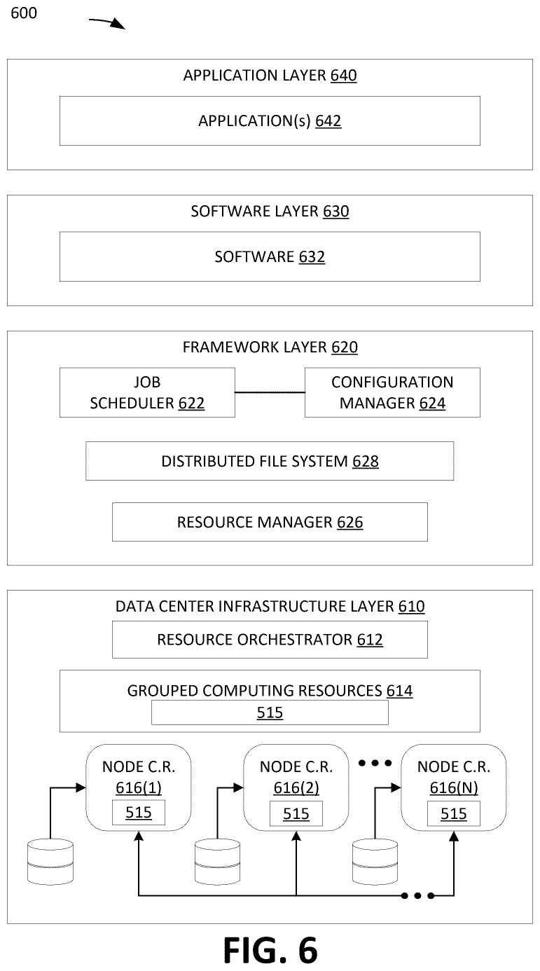

FIG. 6 illustrates an example data center 600, in which at least one embodiment may be used. For example, the data center 600 may house server device 160, data store 150 and/or computing device 102 of FIG. 1 in embodiments. In at least one embodiment, data center 600 includes a data center infrastructure layer 610, a framework layer 620, a software layer 630, and an application layer 640.

In at least one embodiment, as shown in FIG. 6, data center infrastructure layer 610 may include a resource orchestrator 612, grouped computing resources 614, and node computing resources (“node C.R.s”) 616(1)-1016(N), where “N” represents any whole, positive integer. In at least one embodiment, node C.R.s 616(1)-1016(N) may include, but are not limited to, any number of central processing units (“CPUs”) or other processors (including accelerators, field programmable gate arrays (FPGAs), data processing units, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 616(1)-1016(N) may be a server having one or more of above-mentioned computing resources.

In at least one embodiment, grouped computing resources 614 may include separate groupings of node C.R.s housed within one or more racks (not shown), or many racks housed in data centers at various geographical locations (also not shown). Separate groupings of node C.R.s within grouped computing resources 614 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 612 may configure or otherwise control one or more node C.R.s 616(1)-1016(N) and/or grouped computing resources 614. In at least one embodiment, resource orchestrator 612 may include a software design infrastructure (“SDI”) management entity for data center 600. In at least one embodiment, resource orchestrator may include hardware, software or some combination thereof.

In at least one embodiment, as shown in FIG. 6, framework layer 620 includes a job scheduler 622, a configuration manager 624, a resource manager 626 and a distributed file system 628. In at least one embodiment, framework layer 620 may include a framework to support software 632 of software layer 630 and/or one or more application(s) 642 of application layer 640. In at least one embodiment, software 632 or application(s) 642 may respectively include web-based service software or applications, such as those provided by Amazon Web Services, Google Cloud and Microsoft Azure. In at least one embodiment, framework layer 620 may be, but is not limited to, a type of free and open-source software web application framework such as Apache Spark™ (hereinafter “Spark”) that may utilize distributed file system 628 for large-scale data processing (e.g., “big data”). In at least one embodiment, job scheduler 622 may include a Spark driver to facilitate scheduling of workloads supported by various layers of data center 600. In at least one embodiment, configuration manager 624 may be capable of configuring different layers such as software layer 630 and framework layer 620 including Spark and distributed file system 628 for supporting large-scale data processing. In at least one embodiment, resource manager 626 may be capable of managing clustered or grouped computing resources mapped to or allocated for support of distributed file system 628 and job scheduler 622. In at least one embodiment, clustered or grouped computing resources may include grouped computing resource 614 at data center infrastructure layer 610. In at least one embodiment, resource manager 626 may coordinate with resource orchestrator 612 to manage these mapped or allocated computing resources.

In at least one embodiment, software 632 included in software layer 630 may include software used by at least portions of node C.R.s 616(1)-1016(N), grouped computing resources 614, and/or distributed file system 628 of framework layer 620. The one or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-1016(N), grouped computing resources 614, and/or distributed file system 628 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 624, resource manager 626, and resource orchestrator 612 may implement any number and type of self-modifying actions based on any amount and type of data acquired in any technically feasible fashion. In at least one embodiment, self-modifying actions may relieve a data center operator of data center 600 from making possibly bad configuration decisions and possibly avoiding underutilized and/or poor performing portions of a data center.

In at least one embodiment, data center 600 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 600. In at least one embodiment, trained machine learning models corresponding to one or more neural networks may be used to infer or predict information using resources described above with respect to data center 600 by using weight parameters calculated through one or more training techniques described herein.

In at least one embodiment, data center may use CPUs, application-specific integrated circuits (ASICs), GPUs, DPUs FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. Details regarding inference and/or training logic 515 are provided below in conjunction with FIGS. 5A and/or 5B. In at least one embodiment, inference and/or training logic 515 may be used in system FIG. 6 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

### Computer Systems

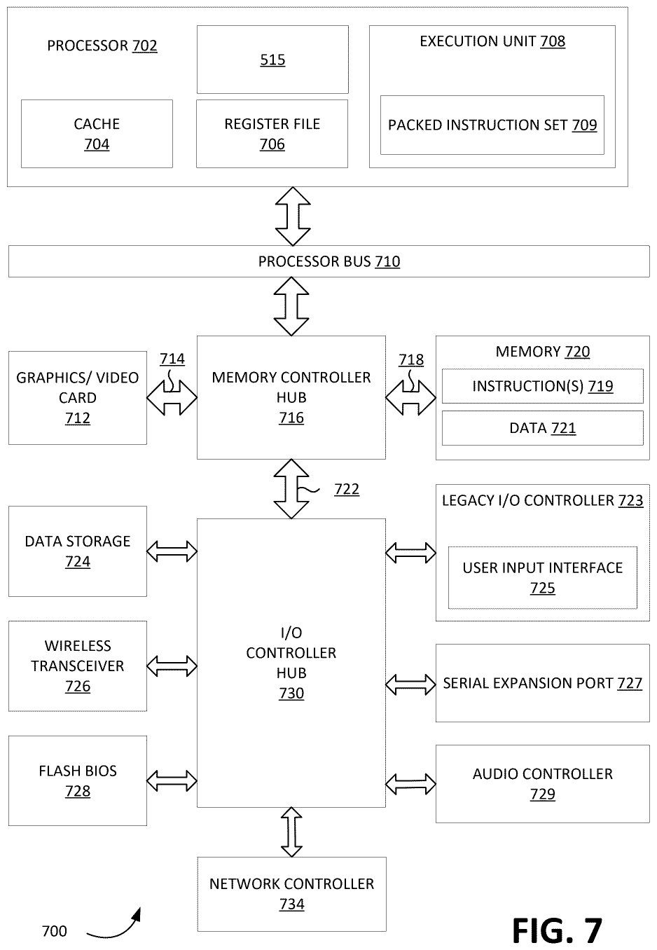

FIG. 7 is a block diagram illustrating an exemplary computer system 700, which may be a system with interconnected devices and components, a system-on-a-chip (SOC) or some combination thereof 700 formed with a processor that may include execution units to execute an instruction, according to at least one embodiment. In some embodiments, the computer system 700 can correspond to server device 160 and/or computing device 102 of FIG. 1. In at least one embodiment, computer system 700 may include, without limitation, a component, such as a processor 702 to employ execution units including logic to perform algorithms for process data, in accordance with present disclosure, such as in embodiment described herein. For example, processor 702 can be configured to execute instructions for implementing a multimodal interaction system for digital humans with engagement and pose analysis. In at least one embodiment, computer system 700 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 700 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IT”) devices, or any other system that may perform one or more instructions in accordance with at least one embodiment.

In at least one embodiment, computer system 700 may include, without limitation, processor 702 that may include, without limitation, one or more execution units 708 to perform machine learning model training and/or inferencing according to techniques described herein. In at least one embodiment, computer system 700 is a single processor desktop or server system, but in another embodiment computer system 700 may be a multiprocessor system. In at least one embodiment, processor 702 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 702 may be coupled to a processor bus 710 that may transmit data signals between processor 702 and other components in computer system 700.

In at least one embodiment, processor 702 may include, without limitation, a Level 1 (“L1”) internal cache memory (“cache”) 704. In at least one embodiment, processor 702 may have a single internal cache or multiple levels of internal cache. In at least one embodiment, cache memory may reside external to processor 702. Other embodiments may also include a combination of both internal and external caches depending on particular implementation and needs. In at least one embodiment, register file 706 may store different types of data in various registers including, without limitation, integer registers, floating point registers, status registers, and instruction pointer register.

In at least one embodiment, execution unit 708, including, without limitation, logic to perform integer and floating point operations, also resides in processor 702. In at least one embodiment, processor 702 may also include a microcode (“ucode”) read only memory (“ROM”) that stores microcode for certain macro instructions. In at least one embodiment, execution unit 708 may include logic to handle a packed instruction set 709. In at least one embodiment, by including packed instruction set 709 in an instruction set of a general-purpose processor 702, along with associated circuitry to execute instructions, operations used by many multimedia applications may be performed using packed data in a general-purpose processor 702. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 708 may also be used in microcontrollers, embedded processors, graphics devices, DSPs, and other types of logic circuits. In at least one embodiment, computer system 700 may include, without limitation, a memory 720. In at least one embodiment, memory 720 may be implemented as a Dynamic Random Access Memory (“DRAM”) device, a Static Random Access Memory (“SRAM”) device, flash memory device, or other memory device. In at least one embodiment, memory 720 may store instruction(s) 719 and/or data 721 represented by data signals that may be executed by processor 702.

In at least one embodiment, system logic chip may be coupled to processor bus 710 and memory 720. In at least one embodiment, system logic chip may include, without limitation, a memory controller hub (“MCH”) 716, and processor 702 may communicate with MCH 716 via processor bus 710. In at least one embodiment, MCH 716 may provide a high bandwidth memory path 718 to memory 720 for instruction and data storage and for storage of graphics commands, data and textures. In at least one embodiment, MCH 716 may direct data signals between processor 702, memory 720, and other components in computer system 700 and to bridge data signals between processor bus 710, memory 720, and a system I/O 722. In at least one embodiment, system logic chip may provide a graphics port for coupling to a graphics controller. In at least one embodiment, MCH 716 may be coupled to memory 720 through a high bandwidth memory path 718 and graphics/video card 712 may be coupled to MCH 716 through an Accelerated Graphics Port (“AGP”) interconnect 714.

In at least one embodiment, computer system 700 may use system I/O 722 that is a proprietary hub interface bus to couple MCH 716 to I/O controller hub (“ICH”) 730. In at least one embodiment, ICH 730 may provide direct connections to some I/O devices via a local I/O bus. In at least one embodiment, local I/O bus may include, without limitation, a high-speed I/O bus for connecting peripherals to memory 720, chipset, and processor 702. Examples may include, without limitation, an audio controller 729, a firmware hub (“flash BIOS”) 728, a wireless transceiver 726, a data storage 724, a legacy I/O controller 723 containing user input and keyboard interfaces 725, a serial expansion port 727, such as Universal Serial Bus (“USB”), and a network controller 734, which may include in some embodiments, a data processing unit. Data storage 724 may comprise a hard disk drive, a floppy disk drive, a CD-ROM device, a flash memory device, or other mass storage device.

In at least one embodiment, FIG. 7 illustrates a system, which includes interconnected hardware devices or “chips”, whereas in other embodiments, FIG. 7 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 700 are interconnected using compute express link (CXL) interconnects.

Inference and/or training logic 515 are used to perform inferencing and/or training operations associated with one or more embodiments. Details regarding inference and/or training logic 515 are provided below in conjunction with FIGS. 5A and/or B. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

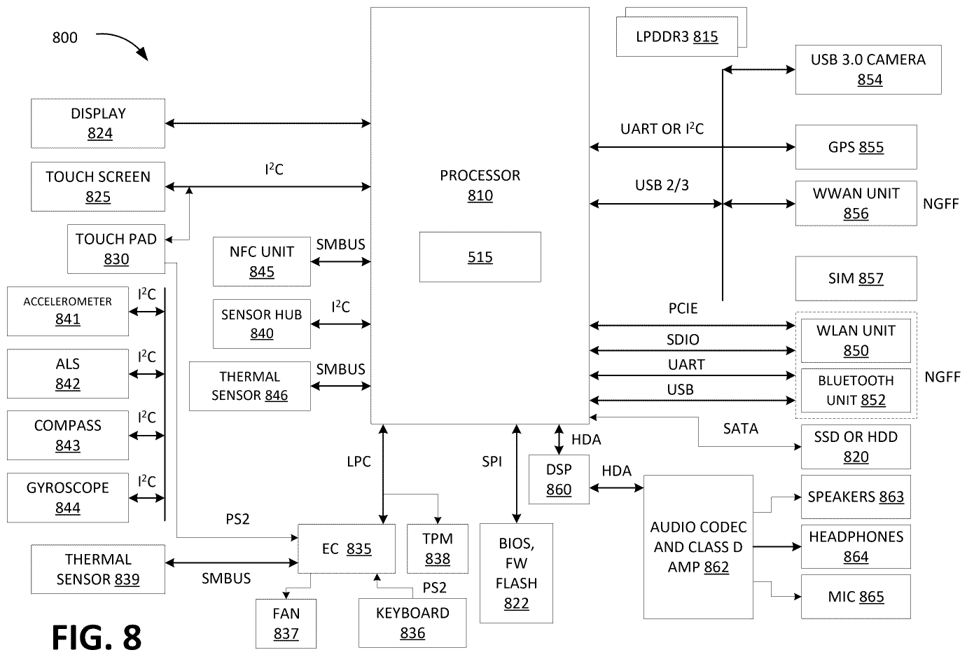

FIG. 8 is a block diagram illustrating an electronic device 800 for utilizing a processor 810, according to at least one embodiment. In at least one embodiment, electronic device 800 may be, for example and without limitation, a notebook, a tower server, a rack server, a blade server, a laptop, a desktop, a tablet, a mobile device, a phone, an embedded computer, an edge device, an IoT device, or any other suitable electronic device. For example, electronic device 800 can correspond to computing device 102 and/or server device 160 of FIG. 1.

In at least one embodiment, system 800 may include, without limitation, processor 810 communicatively coupled to any suitable number or kind of components, peripherals, modules, or devices. In at least one embodiment, processor 810 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices illustrated in FIG. 8 may be interconnected with proprietary interconnects, standardized interconnects (e.g., PCIe) or some combination thereof. In at least one embodiment, one or more components of FIG. 8 are interconnected using compute express link (CXL) interconnects.

In at least one embodiment, FIG. 8 may include a display 824, a touch screen 825, a touch pad 830, a Near Field Communications unit (“NFC”) 845, a sensor hub 840, a thermal sensor 846, an Express Chipset (“EC”) 835, a Trusted Platform Module (“TPM”) 838, BIOS/firmware/flash memory (“BIOS, FW Flash”) 822, a DS P860, a drive 820 such as a Solid State Disk (“SSD”) or a Hard Disk Drive (“HDD”), a wireless local area network unit (“WLAN”) 850, a Bluetooth unit 852, a Wireless Wide Area Network unit (“WWAN”) 856, a Global Positioning System (GPS) 855, a camera (“USB 3.0 camera”) 854 such as a USB 3.0 camera, and/or a Low Power Double Data Rate (“LPDDR”) memory unit (“LPDDR3”) 815 implemented in, for example, LPDDR3 standard. These components may each be implemented in any suitable manner.

In at least one embodiment, other components may be communicatively coupled to processor 810 through components discussed above. In at least one embodiment, an accelerometer 841, Ambient Light Sensor (“ALS”) 842, compass 843, and a gyroscope 844 may be communicatively coupled to sensor hub 840. In at least one embodiment, thermal sensor 839, a fan 837, a keyboard 836, and a touch pad 830 may be communicatively coupled to EC 835. In at least one embodiment, speaker 863, headphones 864, and microphone (“mic”) 865 may be communicatively coupled to an audio unit (“audio codec and class d amp”) 862, which may in turn be communicatively coupled to DSP 860. In at least one embodiment, audio unit 864 may include, for example and without limitation, an audio coder/decoder (“codec”) and a class D amplifier. In at least one embodiment, SIM card (“SIM”) 857 may be communicatively coupled to WWAN unit 856. In at least one embodiment, components such as WLAN unit 850 and Bluetooth unit 852, as well as WWAN unit 856 may be implemented in a Next Generation Form Factor (“NGFF”).

Inference and/or training logic 515 are used to perform inferencing and/or training operations associated with one or more embodiments. Details regarding inference and/or training logic 515 are provided below in conjunction with FIGS. 5A and/or 5B. In at least one embodiment, inference and/or training logic 515 may be used in system FIG. 8 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

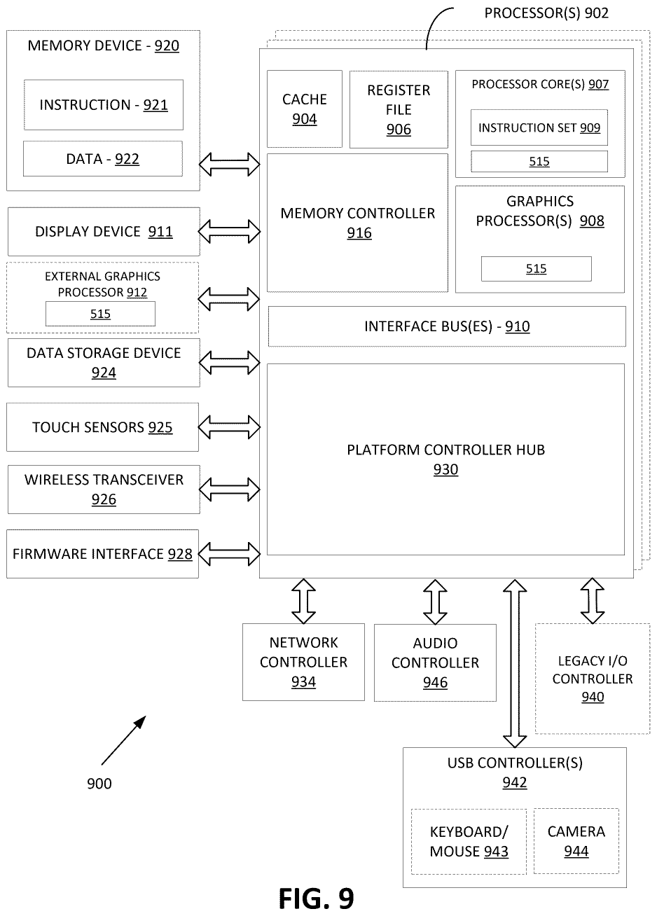

FIG. 9 is a block diagram of a processing system 900, according to at least one embodiment. For example, processing system 900 can correspond to server device 160, data store 150, and/or computing device 102 of FIG. 1 in embodiments. In at least one embodiment, system 900 includes one or more processors 902 and one or more graphics processors 908, and may be a single processor desktop system, a multiprocessor workstation system, or a server system having a large number of processors 902 or processor cores 907. In at least one embodiment, system 900 is a processing platform incorporated within a system-on-a-chip (SoC) integrated circuit for use in mobile, handheld, edge, or embedded devices.

In at least one embodiment, system 900 may include, or be incorporated within a server-based gaming platform, a game console, including a game and media console, a mobile gaming console, a handheld game console, or an online game console. In at least one embodiment, system 900 is a mobile phone, smart phone, tablet computing device or mobile Internet device. In at least one embodiment, processing system 900 may also include, couple with, or be integrated within a wearable device, such as a smart watch wearable device, smart eyewear device, augmented reality device, or virtual reality device. In at least one embodiment, processing system 900 is a television or set top box device having one or more processors 902 and a graphical interface generated by one or more graphics processors 908.

In at least one embodiment, one or more processors 902 each include one or more processor cores 907 to process instructions which, when executed, perform operations for system and user software. In at least one embodiment, each of one or more processor cores 907 is configured to process a specific instruction set 909. In at least one embodiment, instruction set 909 may facilitate Complex Instruction Set Computing (CISC), Reduced Instruction Set Computing (RISC), or computing via a Very Long Instruction Word (VLIW). In at least one embodiment, processor cores 907 may each process a different instruction set 909, which may include instructions to facilitate emulation of other instruction sets. In at least one embodiment, processor core 907 may also include other processing devices, such a Digital Signal Processor (DSP).

In at least one embodiment, processor 902 includes cache memory 904. In at least one embodiment, processor 902 may have a single internal cache or multiple levels of internal cache. In at least one embodiment, cache memory is shared among various components of processor 902. In at least one embodiment, processor 902 also uses an external cache (e.g., a Level-3 (L3) cache or Last Level Cache (LLC)) (not shown), which may be shared among processor cores 907 using known cache coherency techniques. In at least one embodiment, register file 906 is additionally included in processor 902 which may include different types of registers for storing different types of data (e.g., integer registers, floating point registers, status registers, and an instruction pointer register). In at least one embodiment, register file 906 may include general-purpose registers or other registers.

In at least one embodiment, one or more processor(s) 902 are coupled with one or more interface bus(es) 910 to transmit communication signals such as address, data, or control signals between processor 902 and other components in system 900. In at least one embodiment, interface bus 910, in one embodiment, may be a processor bus, such as a version of a Direct Media Interface (DMI) bus. In at least one embodiment, interface 910 is not limited to a DMI bus, and may include one or more Peripheral Component Interconnect buses (e.g., PCI, PCI Express), memory busses, or other types of interface busses. In at least one embodiment processor(s) 902 include an integrated memory controller 916 and a platform controller hub 930. In at least one embodiment, memory controller 916 facilitates communication between a memory device and other components of system 900, while platform controller hub (PCH) 930 provides connections to I/O devices via a local I/O bus.

In at least one embodiment, memory device 920 may be a dynamic random access memory (DRAM) device, a static random access memory (SRAM) device, flash memory device, phase-change memory device, or some other memory device having suitable performance to serve as process memory. In at least one embodiment memory device 920 may operate as system memory for system 900, to store data 922 and instructions 921 for use when one or more processors 902 executes an application or process. In at least one embodiment, memory controller 916 also couples with an optional external graphics processor 912, which may communicate with one or more graphics processors 908 in processors 902 to perform graphics and media operations. In at least one embodiment, a display device 911 may connect to processor(s) 902. In at least one embodiment display device 911 may include one or more of an internal display device, as in a mobile electronic device or a laptop device or an external display device attached via a display interface (e.g., DisplayPort, etc.). In at least one embodiment, display device 911 may include a head mounted display (HMD) such as a stereoscopic display device for use in virtual reality (VR) applications or augmented reality (AR) applications.

In at least one embodiment, platform controller hub 930 enables peripherals to connect to memory device 920 and processor 902 via a high-speed I/O bus. In at least one embodiment, I/O peripherals include, but are not limited to, an audio controller 946, a network controller 934, a firmware interface 928, a wireless transceiver 926, touch sensors 925, a data storage device 924 (e.g., hard disk drive, flash memory, etc.). In at least one embodiment, data storage device 924 may connect via a storage interface (e.g., SATA) or via a peripheral bus, such as a Peripheral Component Interconnect bus (e.g., PCI, PCI Express). In at least one embodiment, touch sensors 925 may include touch screen sensors, pressure sensors, or fingerprint sensors. In at least one embodiment, wireless transceiver 926 may be a Wi-Fi transceiver, a Bluetooth transceiver, or a mobile network transceiver such as a 3G, 4G, or Long Term Evolution (LTE) transceiver. In at least one embodiment, firmware interface 928 enables communication with system firmware, and may be, for example, a unified extensible firmware interface (UEFI). In at least one embodiment, network controller 934 may enable a network connection to a wired network. In at least one embodiment, a high-performance network controller (not shown) couples with interface bus 910. In at least one embodiment, audio controller 946 is a multi-channel high definition audio controller. In at least one embodiment, system 900 includes an optional legacy I/O controller 940 for coupling legacy (e.g., Personal System 2 (PS/2)) devices to system. In at least one embodiment, platform controller hub 930 may also connect to one or more Universal Serial Bus (USB) controllers 942 connect input devices, such as keyboard and mouse 943 combinations, a camera 944, or other USB input devices.

In at least one embodiment, an instance of memory controller 916 and platform controller hub 930 may be integrated into a discreet external graphics processor, such as external graphics processor 912. In at least one embodiment, platform controller hub 930 and/or memory controller 916 may be external to one or more processor(s) 902. For example, in at least one embodiment, system 900 may include an external memory controller 916 and platform controller hub 930, which may be configured as a memory controller hub and peripheral controller hub within a system chipset that is in communication with processor(s) 902.

Inference and/or training logic 515 are used to perform inferencing and/or training operations associated with one or more embodiments. Details regarding inference and/or training logic 515 are provided below in conjunction with FIGS. 5A and/or 5B. In at least one embodiment portions or all of inference and/or training logic 515 may be incorporated into graphics processor 900. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIG. 5A or 5B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

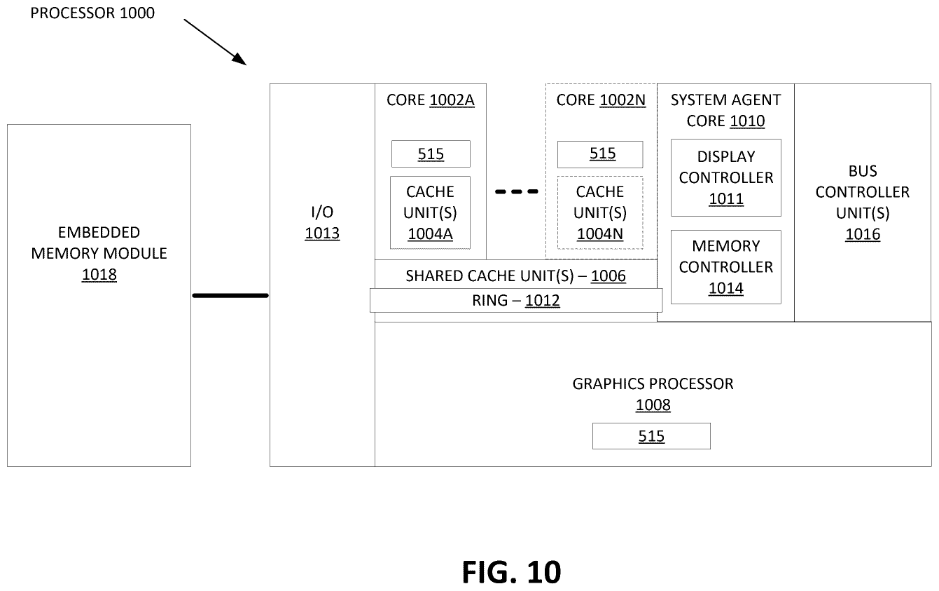

FIG. 10 is a block diagram of a processor 1000 having one or more processor cores 1002A-1002N, an integrated memory controller 1014, and an integrated graphics processor 1008, according to at least one embodiment. For example, processor 1000 may be included in, or otherwise accessed by, server device 160, data store 150, and/or computing device 102 of FIG. 1, in embodiments. In at least one embodiment, processor 1000 may include additional cores up to and including additional core 1002N represented by dashed lined boxes. In at least one embodiment, each of processor cores 1002A-1002N includes one or more internal cache units 1004A-1004N. In at least one embodiment, each processor core also has access to one or more shared cached units 1006.

In at least one embodiment, internal cache units 1004A-1004N and shared cache units 1006 represent a cache memory hierarchy within processor 1000. In at least one embodiment, cache memory units 1004A-1004N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1006 and 1004A-1004N.

In at least one embodiment, processor 1000 may also include a set of one or more bus controller units 1016 and a system agent core 1010. In at least one embodiment, one or more bus controller units 1016 manage a set of peripheral buses, such as one or more PCI or PCI express busses. In at least one embodiment, system agent core 1010 provides management functionality for various processor components. In at least one embodiment, system agent core 1010 includes one or more integrated memory controllers 1014 to manage access to various external memory devices (not shown).

In at least one embodiment, one or more of processor cores 1002A-1002N include support for simultaneous multi-threading. In at least one embodiment, system agent core 1010 includes components for coordinating and operating cores 1002A-1002N during multi-threaded processing. In at least one embodiment, system agent core 1010 may additionally include a power control unit (PCU), which includes logic and components to regulate one or more power states of processor cores 1002A-1002N and graphics processor 1008.

In at least one embodiment, processor 1000 additionally includes graphics processor 1008 to execute graphics processing operations. In at least one embodiment, graphics processor 1008 couples with shared cache units 1006, and system agent core 1010, including one or more integrated memory controllers 1014. In at least one embodiment, system agent core 1010 also includes a display controller 1011 to drive graphics processor output to one or more coupled displays. In at least one embodiment, display controller 1011 may also be a separate module coupled with graphics processor 1008 via at least one interconnect, or may be integrated within graphics processor 1008.

In at least one embodiment, a ring based interconnect unit 1012 is used to couple internal components of processor 1000. In at least one embodiment, an alternative interconnect unit may be used, such as a point-to-point interconnect, a switched interconnect, or other techniques. In at least one embodiment, graphics processor 1008 couples with ring interconnect 1012 via an I/O link 1013.

In at least one embodiment, I/O link 1013 represents at least one of multiple varieties of I/O interconnects, including an on package I/O interconnect which facilitates communication between various processor components and a high-performance embedded memory module 1018, such as an eDRAM module. In at least one embodiment, each of processor cores 1002A-1002N and graphics processor 1008 use embedded memory modules 1018 as a shared Last Level Cache.

In at least one embodiment, processor cores 1002A-1002N are homogenous cores executing a common instruction set architecture. In at least one embodiment, processor cores 1002A-1002N are heterogeneous in terms of instruction set architecture (ISA), where one or more of processor cores 1002A-1002N execute a common instruction set, while one or more other cores of processor cores 1002A-1002N executes a subset of a common instruction set or a different instruction set. In at least one embodiment, processor cores 1002A-1002N are heterogeneous in terms of microarchitecture, where one or more cores having a relatively higher power consumption couple with one or more power cores having a lower power consumption. In at least one embodiment, processor 1000 may be implemented on one or more chips or as an SoC integrated circuit.

Inference and/or training logic 515 are used to perform inferencing and/or training operations associated with one or more embodiments. Details regarding inference and/or training logic 515 are provided below in conjunction with FIGS. 5A and/or 5B. In at least one embodiment portions or all of inference and/or training logic 515 may be incorporated into processor 1000. For example, in at least one embodiment, training and/or inferencing techniques described herein may use one or more of ALUs embodied in graphics processor 1008, graphics core(s) 1002A-1002N, or other components in FIG. 10. Moreover, in at least one embodiment, inferencing and/or training operations described herein may be done using logic other than logic illustrated in FIG. 5A or 5B. In at least one embodiment, weight parameters may be stored in on-chip or off-chip memory and/or registers (shown or not shown) that configure ALUs of graphics processor 1000 to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

### Virtualized Computing Platform

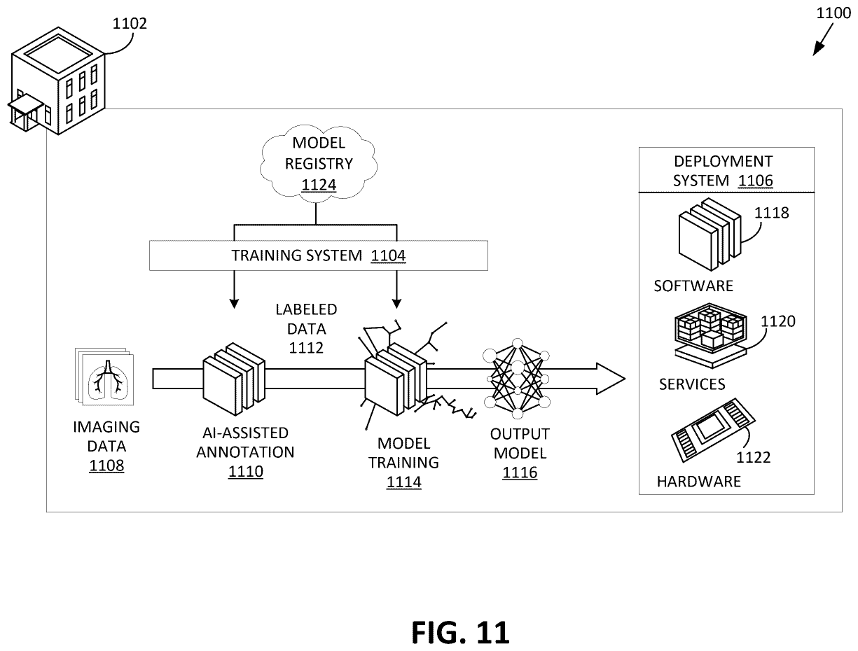

FIG. 11 is an example data flow diagram for a process 1100 of generating and deploying an image processing and inferencing pipeline, in accordance with at least one embodiment, such as with regards to the generation of vision analytics data as described herein. In at least one embodiment, process 1100 may be deployed for use with imaging devices, processing devices, and/or other device types at one or more facilities 1102. Process 1100 may be executed within a training system 1104 and/or a deployment system 1106. In at least one embodiment, training system 1104 may be used to perform training, deployment, and implementation of machine learning models (e.g., neural networks, object detection algorithms, computer vision algorithms, etc.) for use in deployment system 1106. In at least one embodiment, deployment system 1106 may be configured to offload processing and compute resources among a distributed computing environment to reduce infrastructure requirements at facility 1102. In at least one embodiment, one or more applications in a pipeline may use or call upon services (e.g., inference, visualization, compute, AI, etc.) of deployment system 1106 during execution of applications.

In at least one embodiment, some of applications used in advanced processing and inferencing pipelines may use machine learning models or other AI to perform one or more processing steps. In at least one embodiment, machine learning models may be trained at facility 1102 using data 1108 (such as imaging data) generated at facility 1102 (and stored on one or more picture archiving and communication system (PACS) servers at facility 1102), may be trained using imaging or sequencing data 1108 from another facility(ies), or a combination thereof. In at least one embodiment, training system 1104 may be used to provide applications, services, and/or other resources for generating working, deployable machine learning models for deployment system 1106.

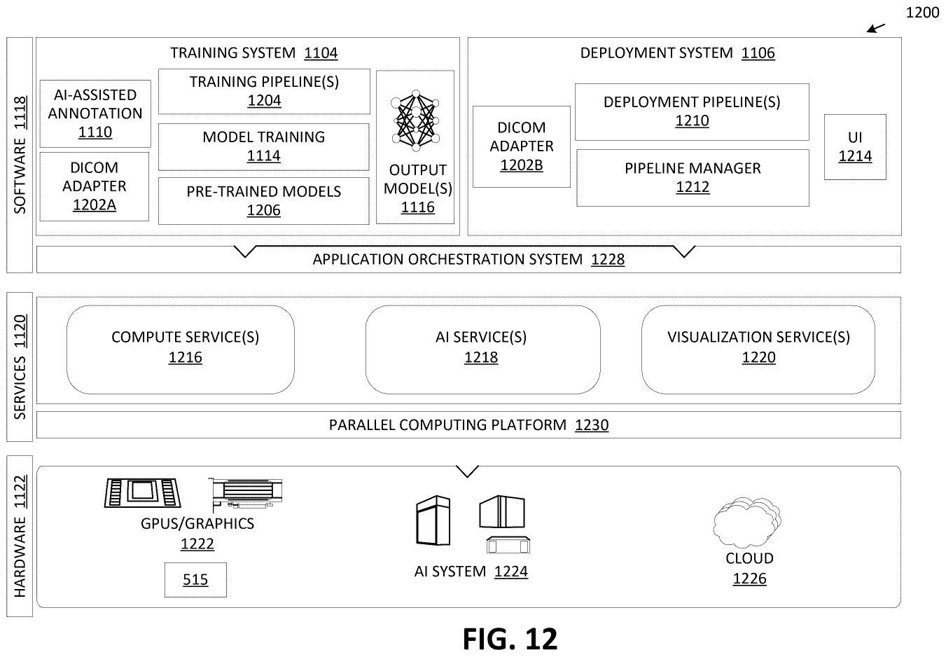

In at least one embodiment, model registry 1124 may be backed by object storage that may support versioning and object metadata. In at least one embodiment, object storage may be accessible through, for example, a cloud storage (e.g., cloud 1226 of FIG. 12) compatible application programming interface (API) from within a cloud platform. In at least one embodiment, machine learning models within model registry 1124 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1204 (FIG. 12) may include a scenario where facility 1102 is training their own machine learning model, or has an existing machine learning model that needs to be optimized or updated. In at least one embodiment, imaging data 1108 generated by imaging device(s), sequencing devices, and/or other device types may be received. In at least one embodiment, once imaging data 1108 is received, AI-assisted annotation 1110 may be used to aid in generating annotations corresponding to imaging data 1108 to be used as ground truth data for a machine learning model. In at least one embodiment, AI-assisted annotation 1110 may include one or more machine learning models (e.g., convolutional neural networks (CNNs)) that may be trained to generate annotations corresponding to certain types of imaging data 1108 (e.g., from certain devices). In at least one embodiment, AI-assisted annotations 1110 may then be used directly, or may be adjusted or fine-tuned using an annotation tool to generate ground truth data. In at least one embodiment, AI-assisted annotations 1110, labeled clinic data 1112, or a combination thereof may be used as ground truth data for training a machine learning model. In at least one embodiment, a trained machine learning model may be referred to as output model 1116, and may be used by deployment system 1106, as described herein.

In at least one embodiment, training pipeline 1204 (FIG. 12) may include a scenario where facility 1102 needs a machine learning model for use in performing one or more processing tasks for one or more applications in deployment system 1106, but facility 1102 may not currently have such a machine learning model (or may not have a model that is optimized, efficient, or effective for such purposes). In at least one embodiment, an existing machine learning model may be selected from a model registry 1124. In at least one embodiment, model registry 1124 may include machine learning models trained to perform a variety of different inference tasks on imaging data. In at least one embodiment, machine learning models in model registry 1124 may have been trained on imaging data from different facilities than facility 1102 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1124. In at least one embodiment, a machine learning model may then be retrained, or updated, at any number of other facilities, and a retrained or updated model may be made available in model registry 1124. In at least one embodiment, a machine learning model may then be selected from model registry 1124—and referred to as output model 1116—and may be used in deployment system 1106 to perform one or more processing tasks for one or more applications of a deployment system.

In at least one embodiment, training pipeline 1204 (FIG. 12), a scenario may include facility 1102 requiring a machine learning model for use in performing one or more processing tasks for one or more applications in deployment system 1106, but facility 1102 may not currently have such a machine learning model (or may not have a model that is optimized, efficient, or effective for such purposes). In at least one embodiment, a machine learning model selected from model registry 1124 may not be fine-tuned or optimized for imaging data 1108 generated at facility 1102 because of differences in populations, robustness of training data used to train a machine learning model, diversity in anomalies of training data, and/or other issues with training data. In at least one embodiment, AI-assisted annotation 1110 may be used to aid in generating annotations corresponding to imaging data 1108 to be used as ground truth data for retraining or updating a machine learning model. In at least one embodiment, labeled data 1112 may be used as ground truth data for training a machine learning model. In at least one embodiment, retraining or updating a machine learning model may be referred to as model training 1114. In at least one embodiment, model training 1114—e.g., AI-assisted annotations 1110, labeled clinic data 1112, or a combination thereof—may be used as ground truth data for retraining or updating a machine learning model. In at least one embodiment, a trained machine learning model may be referred to as output model 1116, and may be used by deployment system 1106, as described herein.

In at least one embodiment, deployment system 1106 may include software 1118, services 1120, hardware 1122, and/or other components, features, and functionality. In at least one embodiment, deployment system 1106 may include a software “stack,” such that software 1118 may be built on top of services 1120 and may use services 1120 to perform some or all of processing tasks, and services 1120 and software 1118 may be built on top of hardware 1122 and use hardware 1122 to execute processing, storage, and/or other compute tasks of deployment system 1106. In at least one embodiment, software 1118 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1108, in addition to containers that receive and configure imaging data for use by each container and/or for use by facility 1102 after processing through a pipeline (e.g., to convert outputs back to a usable data type). In at least one embodiment, a combination of containers within software 1118 (e.g., that make up a pipeline) may be referred to as a virtual instrument (as described in more detail herein), and a virtual instrument may leverage services 1120 and hardware 1122 to execute some or all processing tasks of applications instantiated in containers.

In at least one embodiment, a data processing pipeline may receive input data (e.g., imaging data 1108) in a specific format in response to an inference request (e.g., a request from a user of deployment system 1106). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1116 of training system 1104.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1124 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1120 as a system (e.g., system 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1200 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1200 of FIG. 12). In at least one embodiment, completed and validated applications or containers may be stored in a container registry and associated machine learning models may be stored in model registry 1124. In at least one embodiment, a requesting entity-who provides an inference or image processing request—may browse a container registry and/or model registry 1124 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1106 (e.g., a cloud) to perform processing of data processing pipeline. In at least one embodiment, processing by deployment system 1106 may include referencing selected elements (e.g., applications, containers, models, etc.) from a container registry and/or model registry 1124. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1120 may be leveraged. In at least one embodiment, services 1120 may include compute services, artificial intelligence (AI) services, visualization services, and/or other service types. In at least one embodiment, services 1120 may provide functionality that is common to one or more applications in software 1118, so functionality may be abstracted to a service that may be called upon or leveraged by applications. In at least one embodiment, functionality provided by services 1120 may run dynamically and more efficiently, while also scaling well by allowing applications to process data in parallel (e.g., using a parallel computing platform 1230 (FIG. 12)). In at least one embodiment, rather than each application that shares a same functionality offered by a service 1120 being required to have a respective instance of service 1120, service 1120 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a service 1120 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1118 implementing advanced processing and inferencing pipeline that includes segmentation application and anomaly detection application may be streamlined because each application may call upon a same inference service to perform one or more inferencing tasks.

In at least one embodiment, hardware 1122 may include GPUs, CPUs, DPUs, graphics cards, an AI/deep learning system (e.g., an AI supercomputer, such as NVIDIA's DGX), a cloud platform, or a combination thereof. In at least one embodiment, different types of hardware 1122 may be used to provide efficient, purpose-built support for software 1118 and services 1120 in deployment system 1106. In at least one embodiment, use of GPU processing may be implemented for processing locally (e.g., at facility 1102), within an AI/deep learning system, in a cloud system, and/or in other processing components of deployment system 1106 to improve efficiency, accuracy, and efficacy of image processing and generation. In at least one embodiment, software 1118 and/or services 1120 may be optimized for GPU processing with respect to deep learning, machine learning, and/or high-performance computing, as non-limiting examples. In at least one embodiment, at least some of computing environment of deployment system 1106 and/or training system 1104 may be executed in a datacenter one or more supercomputers or high performance computing systems, with GPU optimized software (e.g., hardware and software combination of NVIDIA's DGX System). In at least one embodiment, hardware 1122 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform may further include DPU processing to transmit data received over a network and/or through a network controller or other network interface directly to (e.g., a memory of) one or more GPU(s). In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 12 is a system diagram for an example system 1200 for generating and deploying an imaging deployment pipeline, in accordance with at least one embodiment, such as with regards to the generation of vision analytics data as described herein. In at least one embodiment, system 1200 may be used to implement process 1100 of FIG. 11 and/or other processes including advanced processing and inferencing pipelines. In at least one embodiment, system 1200 may include training system 1104 and deployment system 1106. In at least one embodiment, training system 1104 and deployment system 1106 may be implemented using software 1118, services 1120, and/or hardware 1122, as described herein.

In at least one embodiment, system 1200 (e.g., training system 1104 and/or deployment system 1106) may implemented in a cloud computing environment (e.g., using cloud 1226). In at least one embodiment, system 1200 may be implemented locally with respect to a healthcare services facility, or as a combination of both cloud and local computing resources. In at least one embodiment, access to APIs in cloud 1226 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1200, may be restricted to a set of public IPs that have been vetted or authorized for interaction.

In at least one embodiment, various components of system 1200 may communicate between and among one another using any of a variety of different network types, including but not limited to local area networks (LANs) and/or wide area networks (WANs) via wired and/or wireless communication protocols. In at least one embodiment, communication between facilities and components of system 1200 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1104 may execute training pipelines 1204, similar to those described herein with respect to FIG. 11. In at least one embodiment, where one or more machine learning models are to be used in deployment pipelines 1210 by deployment system 1106, training pipelines 1204 may be used to train or retrain one or more (e.g. pre-trained) models, and/or implement one or more of pre-trained models 1206 (e.g., without a need for retraining or updating). In at least one embodiment, as a result of training pipelines 1204, output model(s) 1116 may be generated. In at least one embodiment, training pipelines 1204 may include any number of processing steps, such as but not limited to imaging data (or other input data) conversion or adaption In at least one embodiment, for different machine learning models used by deployment system 1106, different training pipelines 1204 may be used. In at least one embodiment, training pipeline 1204 similar to a first example described with respect to FIG. 11 may be used for a first machine learning model, training pipeline 1204 similar to a second example described with respect to FIG. 11 may be used for a second machine learning model, and training pipeline 1204 similar to a third example described with respect to FIG. 11 may be used for a third machine learning model. In at least one embodiment, any combination of tasks within training system 1104 may be used depending on what is required for each respective machine learning model. In at least one embodiment, one or more of machine learning models may already be trained and ready for deployment so machine learning models may not undergo any processing by training system 1104, and may be implemented by deployment system 1106.

In at least one embodiment, output model(s) 1116 and/or pre-trained model(s) 1206 may include any types of machine learning models depending on implementation or embodiment. In at least one embodiment, and without limitation, machine learning models used by system 1200 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

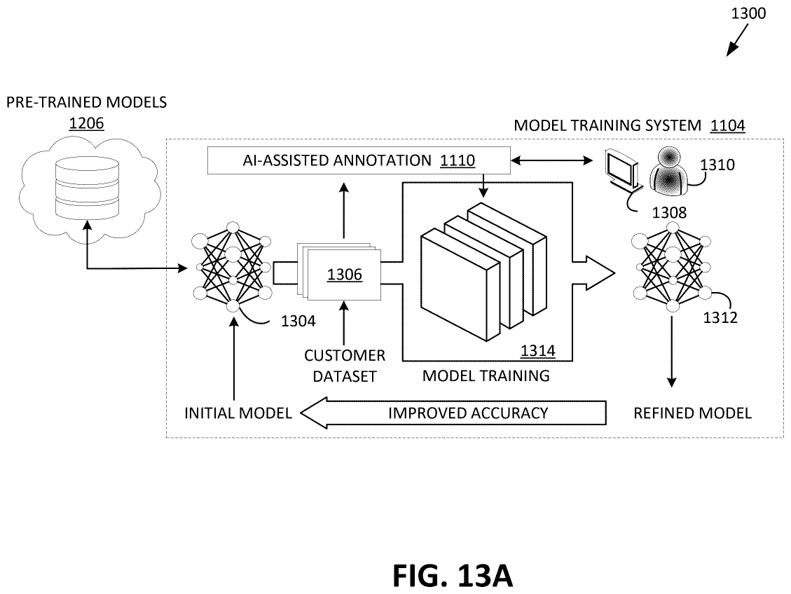

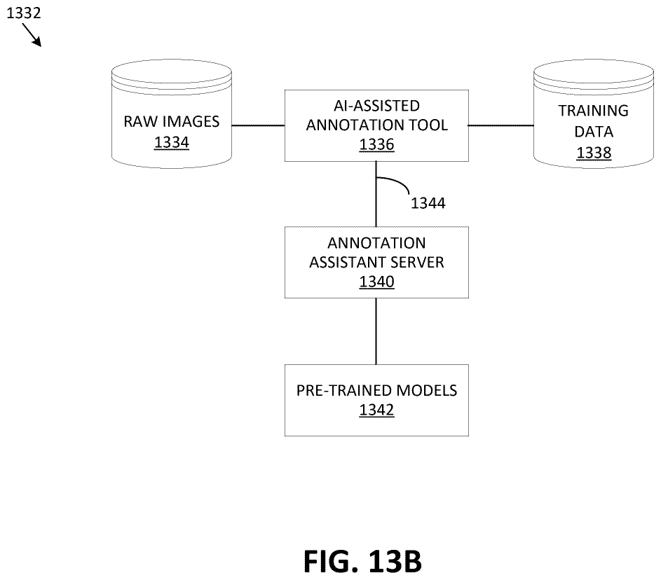

In at least one embodiment, training pipelines 1204 may include AI-assisted annotation, as described in more detail herein with respect to at least FIG. 13B. In at least one embodiment, labeled data 1112 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1108 (or other data type used by machine learning models), there may be corresponding ground truth data generated by training system 1104. In at least one embodiment, AI-assisted annotation may be performed as part of deployment pipelines 1210; either in addition to, or in lieu of AI-assisted annotation included in training pipelines 1204. In at least one embodiment, system 1200 may include a multi-layer platform that may include a software layer (e.g., software 1118) of diagnostic applications (or other application types) that may perform one or more medical imaging and diagnostic functions. In at least one embodiment, system 1200 may be communicatively coupled to (e.g., via encrypted links) PACS server networks of one or more facilities. In at least one embodiment, system 1200 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1102). In at least one embodiment, applications may then call or execute one or more services 1120 for performing compute, AI, or visualization tasks associated with respective applications, and software 1118 and/or services 1120 may leverage hardware 1122 to perform processing tasks in an effective and efficient manner.

In at least one embodiment, deployment system 1106 may execute deployment pipelines 1210. In at least one embodiment, deployment pipelines 1210 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline 1210 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline 1210 depending on information desired from data generated by a device. In at least one embodiment, where detections of anomalies are desired from an MRI machine, there may be a first deployment pipeline 1210, and where image enhancement is desired from output of an MRI machine, there may be a second deployment pipeline 1210.

In at least one embodiment, an image generation application may include a processing task that includes use of a machine learning model. In at least one embodiment, a user may desire to use their own machine learning model, or to select a machine learning model from model registry 1124. In at least one embodiment, a user may implement their own machine learning model or select a machine learning model for inclusion in an application for performing a processing task. In at least one embodiment, applications may be selectable and customizable, and by defining constructs of applications, deployment, and implementation of applications for a particular user are presented as a more seamless user experience. In at least one embodiment, by leveraging other features of system 1200—such as services 1120 and hardware 1122—deployment pipelines 1210 may be even more user friendly, provide for easier integration, and produce more accurate, efficient, and timely results.

In at least one embodiment, deployment system 1106 may include a user interface 1214 (e.g., a graphical user interface, a web interface, etc.) that may be used to select applications for inclusion in deployment pipeline(s) 1210, arrange applications, modify, or change applications or parameters or constructs thereof, use and interact with deployment pipeline(s) 1210 during set-up and/or deployment, and/or to otherwise interact with deployment system 1106. In at least one embodiment, although not illustrated with respect to training system 1104, user interface 1214 (or a different user interface) may be used for selecting models for use in deployment system 1106, for selecting models for training, or retraining, in training system 1104, and/or for otherwise interacting with training system 1104.

In at least one embodiment, pipeline manager 1212 may be used, in addition to an application orchestration system 1228, to manage interaction between applications or containers of deployment pipeline(s) 1210 and services 1120 and/or hardware 1122. In at least one embodiment, pipeline manager 1212 may be configured to facilitate interactions from application to application, from application to service 1120, and/or from application or service to hardware 1122. In at least one embodiment, although illustrated as included in software 1118, this is not intended to be limiting, and in some examples (e.g., as illustrated in FIG. 10) pipeline manager 1212 may be included in services 1120. In at least one embodiment, application orchestration system 1228 (e.g., Kubernetes, DOCKER, etc.) may include a container orchestration system that may group applications into containers as logical units for coordination, management, scaling, and deployment. In at least one embodiment, by associating applications from deployment pipeline(s) 1210 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1212 and application orchestration system 1228. In at least one embodiment, so long as an expected input and/or output of each container or application is known by a system (e.g., based on constructs of applications or containers), application orchestration system 1228 and/or pipeline manager 1212 may facilitate communication among and between, and sharing of resources among and between, each of applications or containers. In at least one embodiment, because one or more of applications or containers in deployment pipeline(s) 1210 may share same services and resources, application orchestration system 1228 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1228) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1120 leveraged by and shared by applications or containers in deployment system 1106 may include compute services 1216, AI services 1218, visualization services 1220, and/or other service types. In at least one embodiment, applications may call (e.g., execute) one or more of services 1120 to perform processing operations for an application. In at least one embodiment, compute services 1216 may be leveraged by applications to perform super-computing or other high-performance computing (HPC) tasks. In at least one embodiment, compute service(s) 1216 may be leveraged to perform parallel processing (e.g., using a parallel computing platform 1230) for processing data through one or more of applications and/or one or more tasks of a single application, substantially simultaneously. In at least one embodiment, parallel computing platform 1230 (e.g., NVIDIA's CUDA) may enable general purpose computing on GPUs (GPGPU) (e.g., GPUs 1222). In at least one embodiment, a software layer of parallel computing platform 1230 may provide access to virtual instruction sets and parallel computational elements of GPUs, for execution of compute kernels. In at least one embodiment, parallel computing platform 1230 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1230 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1218 may be leveraged to perform inferencing services for executing machine learning model(s) associated with applications (e.g., tasked with performing one or more processing tasks of an application). In at least one embodiment, AI services 1218 may leverage AI system 1224 to execute machine learning model(s) (e.g., neural networks, such as CNNs) for segmentation, reconstruction, object detection, feature detection, classification, and/or other inferencing tasks. In at least one embodiment, applications of deployment pipeline(s) 1210 may use one or more of output models 1116 from training system 1104 and/or other models of applications to perform inference on imaging data. In at least one embodiment, two or more examples of inferencing using application orchestration system 1228 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1228 may distribute resources (e.g., services 1120 and/or hardware 1122) based on priority paths for different inferencing tasks of AI services 1218.

In at least one embodiment, shared storage may be mounted to AI services 1218 within system 1200. In at least one embodiment, shared storage may operate as a cache (or other storage device type) and may be used to process inference requests from applications. In at least one embodiment, when an inference request is submitted, a request may be received by a set of API instances of deployment system 1106, and one or more instances may be selected (e.g., for best fit, for load balancing, etc.) to process a request. In at least one embodiment, to process a request, a request may be entered into a database, a machine learning model may be located from model registry 1124 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1212) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s) and/or DPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<11 min). In at least one embodiment, model execution times may be measured from requesting institution or entity and may include partner network traversal time, as well as execution on an inference service.

In at least one embodiment, transfer of requests between services 1120 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1226, and an inference service may perform inferencing on a GPU.

In at least one embodiment, visualization services 1220 may be leveraged to generate visualizations for viewing outputs of applications and/or deployment pipeline(s) 1210. In at least one embodiment, GPUs 1222 may be leveraged by visualization services 1220 to generate visualizations. In at least one embodiment, rendering effects, such as ray-tracing, may be implemented by visualization services 1220 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1220 may include an internal visualizer, cinematics, and/or other rendering or image processing capabilities or functionality (e.g., ray tracing, rasterization, internal optics, etc.).

In at least one embodiment, hardware 1122 may include GPUs 1222, AI system 1224, cloud 1226, and/or any other hardware used for executing training system 1104 and/or deployment system 1106. In at least one embodiment, GPUs 1222 (e.g., NVIDIA's TESLA and/or QUADRO GPUs) may include any number of GPUs that may be used for executing processing tasks of compute services 1216, AI services 1218, visualization services 1220, other services, and/or any of features or functionality of software 1118. For example, with respect to AI services 1218, GPUs 1222 may be used to perform pre-processing on imaging data (or other data types used by machine learning models), post-processing on outputs of machine learning models, and/or to perform inferencing (e.g., to execute machine learning models). In at least one embodiment, cloud 1226, AI system 1224, and/or other components of system 1200 may use GPUs 1222. In at least one embodiment, cloud 1226 may include a GPU-optimized platform for deep learning tasks. In at least one embodiment, AI system 1224 may use GPUs, and cloud 1226—or at least a portion tasked with deep learning or inferencing—may be executed using one or more AI systems 1224. As such, although hardware 1122 is illustrated as discrete components, this is not intended to be limiting, and any components of hardware 1122 may be combined with, or leveraged by, any other components of hardware 1122.

In at least one embodiment, AI system 1224 may include a purpose-built computing system (e.g., a super-computer or an HPC) configured for inferencing, deep learning, machine learning, and/or other artificial intelligence tasks. In at least one embodiment, AI system 1224 (e.g., NVIDIA's DGX) may include GPU-optimized software (e.g., a software stack) that may be executed using a plurality of GPUs 1222, in addition to DPUs, CPUs, RAM, storage, and/or other components, features, or functionality. In at least one embodiment, one or more AI systems 1224 may be implemented in cloud 1226 (e.g., in a data center) for performing some or all of AI-based processing tasks of system 1200.

In at least one embodiment, cloud 1226 may include a GPU-accelerated infrastructure (e.g., NVIDIA's NGC) that may provide a GPU-optimized platform for executing processing tasks of system 1200. In at least one embodiment, cloud 1226 may include an AI system(s) 1224 for performing one or more of AI-based tasks of system 1200 (e.g., as a hardware abstraction and scaling platform). In at least one embodiment, cloud 1226 may integrate with application orchestration system 1228 leveraging multiple GPUs to enable seamless scaling and load balancing between and among applications and services 1120. In at least one embodiment, cloud 1226 may tasked with executing at least some of services 1120 of system 1200, including compute services 1216, AI services 1218, and/or visualization services 1220, as described herein. In at least one embodiment, cloud 1226 may perform small and large batch inference (e.g., executing NVIDIA's TENSOR RT), provide an accelerated parallel computing API and platform 1230 (e.g., NVIDIA's CUDA), execute application orchestration system 1228 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1200.

FIG. 13A illustrates a data flow diagram for a process 1300 to train, retrain, or update a machine learning model, in accordance with at least one embodiment, such as with regards to generating anatomical landmarks, or with regards to speech AI models (e.g., speech recognition or text-to-speech synthesis model). In at least one embodiment, process 1300 may be executed using, as a non-limiting example, system 1200 of FIG. 12. In at least one embodiment, process 1300 may leverage services 1120 and/or hardware 1122 of system 1200, as described herein. In at least one embodiment, refined models 1312 generated by process 1300 may be executed by deployment system 1106 for one or more containerized applications in deployment pipelines 1210.

In at least one embodiment, model training 1114 may include retraining or updating an initial model 1304 (e.g., a pre-trained model) using new training data (e.g., new input data, such as customer dataset 1306, and/or new ground truth data associated with input data). In at least one embodiment, to retrain, or update, initial model 1304, output or loss layer(s) of initial model 1304 may be reset, or deleted, and/or replaced with an updated or new output or loss layer(s). In at least one embodiment, initial model 1304 may have previously fine-tuned parameters (e.g., weights and/or biases) that remain from prior training, so training or retraining 1114 may not take as long or require as much processing as training a model from scratch. In at least one embodiment, during model training 1114, by having reset or replaced output or loss layer(s) of initial model 1304, parameters may be updated and re-tuned for a new data set based on loss calculations associated with accuracy of output or loss layer(s) at generating predictions on new, customer dataset 1306 (e.g., image data 1108 of FIG. 11).

In at least one embodiment, pre-trained models 1206 may be stored in a data store, or registry (e.g., model registry 1124 of FIG. 11). In at least one embodiment, pre-trained models 1206 may have been trained, at least in part, at one or more facilities other than a facility executing process 1300. In at least one embodiment, to protect privacy and rights of patients, subjects, or clients of different facilities, pre-trained models 1206 may have been trained, on-premise, using customer or patient data generated on-premise. In at least one embodiment, pre-trained models 1206 may be trained using cloud 1226 and/or other hardware 1122, but confidential, privacy protected patient data may not be transferred to, used by, or accessible to any components of cloud 1226 (or other off premise hardware). In at least one embodiment, where a pre-trained model 1206 is trained at using patient data from more than one facility, pre-trained model 1206 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model 1206 on-premise and/or off premise, such as in a datacenter or other cloud computing infrastructure.

In at least one embodiment, when selecting applications for use in deployment pipelines 1210, a user may also select machine learning models to be used for specific applications. In at least one embodiment, a user may not have a model for use, so a user may select a pre-trained model 1206 to use with an application. In at least one embodiment, pre-trained model 1206 may not be optimized for generating accurate results on customer dataset 1306 of a facility of a user (e.g., based on patient diversity, demographics, types of medical imaging devices used, etc.). In at least one embodiment, prior to deploying pre-trained model 1206 into deployment pipeline 1210 for use with an application(s), pre-trained model 1206 may be updated, retrained, and/or fine-tuned for use at a respective facility.

In at least one embodiment, a user may select pre-trained model 1206 that is to be updated, retrained, and/or fine-tuned, and pre-trained model 1206 may be referred to as initial model 1304 for training system 1104 within process 1300. In at least one embodiment, customer dataset 1306 (e.g., imaging data, genomics data, sequencing data, or other data types generated by devices at a facility) may be used to perform model training 1114 (which may include, without limitation, transfer learning) on initial model 1304 to generate refined model 1312. In at least one embodiment, ground truth data corresponding to customer dataset 1306 may be generated by training system 1104. In at least one embodiment, ground truth data may be generated, at least in part, by clinicians, scientists, doctors, practitioners, at a facility (e.g., as labeled clinic data 1112 of FIG. 11).

In at least one embodiment, AI-assisted annotation 1110 may be used in some examples to generate ground truth data. In at least one embodiment, AI-assisted annotation 1110 (e.g., implemented using an AI-assisted annotation SDK) may leverage machine learning models (e.g., neural networks) to generate suggested or predicted ground truth data for a customer dataset. In at least one embodiment, user 1310 may use annotation tools within a user interface (a graphical user interface (GUI)) on computing device 1308.

In at least one embodiment, user 1310 may interact with a GUI via computing device 1308 to edit or fine-tune (auto) annotations. In at least one embodiment, a polygon editing feature may be used to move vertices of a polygon to more accurate or fine-tuned locations.

In at least one embodiment, once customer dataset 1306 has associated ground truth data, ground truth data (e.g., from AI-assisted annotation, manual labeling, etc.) may be used by during model training 1114 to generate refined model 1312. In at least one embodiment, customer dataset 1306 may be applied to initial model 1304 any number of times, and ground truth data may be used to update parameters of initial model 1304 until an acceptable level of accuracy is attained for refined model 1312. In at least one embodiment, once refined model 1312 is generated, refined model 1312 may be deployed within one or more deployment pipelines 1210 at a facility for performing one or more processing tasks with respect to medical imaging data.

In at least one embodiment, refined model 1312 may be uploaded to pre-trained models 1206 in model registry 1124 to be selected by another facility. In at least one embodiment, his process may be completed at any number of facilities such that refined model 1312 may be further refined on new datasets any number of times to generate a more universal model.

FIG. 13B is an example illustration of a client-server architecture 1332 to enhance annotation tools with pre-trained annotation models, in accordance with at least one embodiment, such as with regards to implementing a multimodal interaction system for digital humans. In at least one embodiment, AI-assisted annotation tools 1336 may be instantiated based on a client-server architecture 1332. In at least one embodiment, annotation tools 1336 in imaging applications may aid radiologists, for example, identify organs and abnormalities. In at least one embodiment, imaging applications may include software tools that help user 1310 to identify, as a non-limiting example, a few extreme points on a particular organ of interest in raw images 1334 (e.g., in a 3D MRI or CT scan) and receive auto-annotated results for all 2D slices of a particular organ. In at least one embodiment, results may be stored in a data store as training data 1338 and used as (for example and without limitation) ground truth data for training. In at least one embodiment, when computing device 1308 sends extreme points for AI-assisted annotation 1110, a deep learning model, for example, may receive this data as input and return inference results of a segmented organ or abnormality. In at least one embodiment, pre-instantiated annotation tools, such as AI-Assisted Annotation Tool 1336B in FIG. 13B, may be enhanced by making API calls (e.g., API Call 1344) to a server, such as an Annotation Assistant Server 1340 that may include a set of pre-trained models 1342 stored in an annotation model registry, for example. In at least one embodiment, an annotation model registry may store pre-trained models 1342 (e.g., machine learning models, such as deep learning models) that are pre-trained to perform AI-assisted annotation on a particular organ or abnormality. These models may be further updated by using training pipelines 1204. In at least one embodiment, pre-installed annotation tools may be improved over time as new labeled clinic data 1112 is added.

What is claimed is:

1. A method comprising:
receiving a video stream comprising a plurality of frames depicting at least a portion of a user, wherein the video stream is associated with an interaction of the user with an avatar;
determining, for at least one frame of the plurality of frames, a pose orientation corresponding to one or more body landmarks of the user represented in the corresponding frame;
determining, based on at least one pose orientation of a series of pose orientations corresponding to the plurality of frames, an engagement metric of the user; and
causing a representation of the avatar performing an action based on the engagement metric to be generated.

2. The method of claim 1, further comprising:
identifying the one or more body landmarks of the user by providing each frame of the at least one frame of the plurality of frames to a machine learning model that processes the frame and outputs a set of coordinates for each body landmark of the one or more body landmarks.

3. The method of claim 2, wherein the machine learning model further outputs a confidence score for each body landmark of the one or more body landmarks of the user represented in the corresponding frame, the method further comprising:
determining that the confidence score of at least one of the one or more body landmarks exceeds a threshold value; and
including the pose orientation of the corresponding frame in the series of pose orientations.

4. The method of claim 1, further comprising:
applying an exponential weighted average on the series of pose orientations corresponding to the plurality of frames to smooth one or more user movements across the series of pose orientations.

5. The method of claim 1, wherein determining the engagement metric of the user comprises:
comparing the at least one pose orientation of the series of pose orientations to a predetermined user engagement condition, wherein the engagement metric corresponds to a result of the comparison.

6. The method of claim 1, further comprising:
identifying an audio stream corresponding to the video stream;
determining speech timing data of the audio stream; and
determining a correlation between the series of pose orientations corresponding to the plurality of frames and the speech timing data of the audio stream, wherein the engagement metric of the user is further based on the correlation.

7. The method of claim 6, wherein determining the correlation between the series of pose orientations corresponding to the plurality of frames and the speech timing data of the audio stream comprises:
determining an audio processing latency based on an utterance length of the audio stream and a voice activity detection delay associated with the audio stream; and
aligning a timestamp of the engagement metric with a portion of the audio stream corresponding to the utterance length using the audio processing latency to fuse the engagement metric with the speech timing of the audio stream.

8. The method of claim 6, further comprising:
determining a statistical distribution of the series of pose orientations corresponding to the audio stream; and
determining, based on the statistical distribution, a percentage of time during the audio stream that the engagement metric satisfies a threshold, wherein the engagement metric corresponds to the percentage of time.

9. The method of claim 1, wherein at least one pose orientation of the one or more pose orientations represents rotational parameters of a head of the user.

10. The method of claim 1, wherein responsive to determining that the engagement metric satisfies a disengaged criterion, the action causes the representation of the avatar to not respond to the interaction of the user corresponding to the video stream.

11. The method of claim 1, wherein responsive to determining that the engagement metric satisfies a distracted criterion, the action causes the representation of the avatar to (1) request clarification regarding an intent of the user behind the interaction, (2) implement an attention-recovery strategy conversation, or (3) implement temporal buffering.

12. The method of claim 1, wherein responsive to determining that the engagement metric satisfies an attentive criterion, the action causes the representation of the avatar to maintain conversational flow with a standard response timing.

13. A system comprising:
one or more processing units to:
receive a video stream comprising a plurality of frames depicting at least a portion of a user, wherein the video stream is associated with an interaction of the user with an avatar;
determine, for at least one frame of the plurality of frames, a pose orientation corresponding to one or more body landmarks of the user represented in the corresponding frame;
determine, based on at least one pose orientation of a series of pose orientations corresponding to the plurality of frames, an engagement metric of the user; and
cause a representation of the avatar performing an action based on the engagement metric to be generated.

14. The system of claim 13, wherein the one or more processing units further to:
identify the one or more body landmarks of the user by providing each of the at least one frame of the plurality of frames to a machine learning model that processes the frame and outputs a set of coordinates for each body landmark of the one or more body landmarks, wherein the machine learning model further outputs a confidence score for each body landmark of the one or more body landmarks of the user represented in the corresponding frame;
determine that the confidence score of at least one of the one or more body landmarks exceeds a threshold value; and
include the pose orientation of the corresponding frame in the series of pose orientations.

15. The system of claim 13, wherein the one or more processing units further to:
apply an exponential weighted average on the series of pose orientations corresponding to the plurality of frames to smooth one or more user movements across the series of pose orientations.

16. The system of claim 13, wherein the one or more processing units further to:
identify an audio stream corresponding to the video stream;
determining speech timing data of the audio stream; and
determining a correlation between the series of pose orientations corresponding to the plurality of frames and the speech timing data of the audio stream, wherein the engagement metric of the user is further based on the correlation;
determine a statistical distribution of the series of pose orientations corresponding to the audio stream; and
determine, based on the statistical distribution, a percentage of time during the audio stream that the engagement metric satisfies a threshold, wherein the engagement metric corresponds to the percentage of time.

17. The system of claim 16, wherein to determine the correlation between the series of pose orientations corresponding to the plurality of frames and the speech timing data of the audio stream, the one or more processing units further to:
determine an audio processing latency based on an utterance length of the audio stream and a voice activity detection delay associated with the audio stream; and
align a timestamp of the engagement metric with a portion of the audio stream corresponding to the utterance length using the audio processing latency to fuse the engagement metric with the speech timing data of the audio stream.

18. The system of claim 13, wherein responsive to determining that the engagement metric satisfies a disengaged criterion, the action causes the representation of the avatar to not respond to the interaction of the user corresponding to the video stream.

19. The system of claim 13, wherein responsive to determining that the engagement metric satisfies a distracted criterion, the action causes the representation of the avatar to (1) request clarification regarding an intent of the user behind the interaction, (2) implement an attention-recovery strategy conversation, or (3) implement temporal buffering.

20. One or more processors comprising:
circuitry to control a digital human interaction based on a user engagement metric determined based on at least one of a series of pose orientations corresponding to a plurality of frames of a video stream received during an interaction of a user with the digital human.
